(19) United States
(12) Patent Application Publication
(10) Pub. No.: US 2025/0250518 A1
(43) Pub. Date: Aug. 7, 2025

(54) PROCESS FOR REMOVING WATER FROM A FUNCTIONAL INGREDIENT COMPOSITION, AND COMPOSITIONS CONTAINING THE RESULTING PRODUCT

(71) Applicant: CHEMLINK LABORATORIES, LLC, Kennesaw, GA (US)

(72) Inventors: Ryan Giffin Moore, Lilburn, GA (US); Alexander J. Mattingly, Kennesaw, GA (US)

(21) Appl. No.: 18/857,006

(22) PCT Filed: May 22, 2023
(86) PCT No.: PCT/US2023/023046

§ 371 Date: Oct. 15, 2024

Related U.S. Application Data
(60) Provisional application No. 63/345,188, filed on May 24, 2022.

(51) Int. Cl. C11D 11/00; C11D 3/04; C11D 3/10; C11D 3/33; C11D 17/00; F26B 5/16

(52) U.S. Cl. CPC C11D 11/0082; C11D 3/046; C11D 3/10; C11D 3/33; C11D 17/006; F26B 5/16

(57) ABSTRACT

Provided is a process for removing water from a functional ingredient composition that contains 10 wt % or more water, the process requiring no input of thermal energy. The amount of water in the resulting dewatered product is no more than 33% of the starting amount of the water in the functional ingredient, and the method yields a dewatered product that has a weight loss of 2% or less based on the total weight of the starting ingredients.

### RELATED APPLICATION

Benefit of priority is claimed to U.S. Provisional Application No. 63/345,188, titled “PROCESS FOR REMOVING WATER FROM A FUNCTIONAL INGREDIENT COMPOSITION, AND COMPOSITIONS CONTAINING THE RESULTING PRODUCT,” filed May 24, 2022.

Where permitted, the subject matter of the above-referenced application is incorporated by reference in its entirety.

### FIELD

This invention relates generally to a process for removing water from a functional ingredient composition that contains 10 wt % or more water, the process requiring no input of thermal energy. The amount of detectable water in the dewatered product produced by the method is no more than 33% of the starting amount of the water in the functional ingredient composition, or 25% of the starting amount of the water in the functional ingredient composition, or 15% of the starting amount of the water in the functional ingredient composition. The method can yield a dewatered product that has a weight loss of 2% or less based on the difference between the total weight of the starting ingredients and the final weight of the final product. Also provided are compositions that contain the dewatered functional ingredient product produced by the methods herein.

### BACKGROUND

Functional ingredients, such as surfactants, dispersants, anti-redeposition agents, solubility modifiers, rinse aids, odor counteractants, conditioning agents, anti-static agents, soil shielding agents, soil releasing agents, and color protection agents, can sometimes be provided by their manufacturers as compositions that contain 10 wt % or more of water. However, the presence of such relatively high amounts of water can preclude the use of these functional ingredient compositions in some formulations, such as in compositions provided in tablet form.

Compositions in tablet form are known in the art. For example, detergent tablets are described in U.S. Pat. No. 3,953,350 (Fujino et al., 1976). Such tablet compositions are becoming more popular and desirable with consumers. Tablet compositions have several advantages over liquid and powdered products, in that they do not require measuring and are thus easier to handle and dispense by the consumer, and they are more compact, hence facilitating more economical shipping and storage. Compositions in tablet form are generally made by compressing or compacting a quantity of the composition which are generally in particulate form. Functional ingredients that contain water, particularly functional ingredient compositions that contain 10 wt % or more water, may be difficult, if not impossible, to incorporate as-is in typical formulations to be compacted into tablets. The relatively high water content can react with other ingredients in the tablet composition, or can make compression or tablet release impossible. Even if tablets can be made, the relatively high water content can lead to storage stability issues, or can negatively impact tablet hardness, friability, and physical integrity.

Conventional processes for removing water from functional ingredient compositions include application of thermal energy, such as evaporation or heat distillation. Both of these methods can result in loss of functionality of the ingredient, or loss of some portion of the ingredient during the water removal process. Loss of functionality would defeat the whole purpose of going through the effort of removing the water from the as-delivered functional ingredient composition, while loss of ingredient during the water removal process, as well as the costs of energy and equipment needed to remove water using conventional methods, drives up the cost of the final formulation.

Accordingly, a need exists for methods of removing water from functional ingredient compositions that do not negatively impact ingredient functionality or result in lost product, and that can allow functional ingredient compositions having 10 wt % or more water to be used as a component of a composition in the form of a compressed tablet.

### SUMMARY

Provided are methods for removing water from a functional ingredient composition that contains 10 wt % or more water, the process requiring no input of thermal energy. The resulting dewatered product can be in the form of a flowable powder, or the resulting product can be mixed with a flow aid to yield a flowable powder. The amount of detectable water in the dewatered product produced by the methods provided herein is no more than 33% of the starting amount of the water in the functional ingredient, or 25% of the starting amount of the water in the functional ingredient, or 15% of the starting amount of the water in the functional ingredient. The methods provided herein can result in the production of a dewatered product that has a weight loss of 2% or less, or a weight loss of 1% or less, based on the total weight of the starting ingredients. The dewatered product retains the functionality of the functional ingredient, and allows functional ingredient compositions that originally contain 10 wt % or more water as provided by their manufacturer to be converted into a form usable for including in a composition in the form of a tablet, such as a compressed tablet.

Provided herein are eco-friendly, environmentally acceptable, economical, and efficient methods for modifying a functional ingredient composition that contains 10 wt % or more water so that the product can be converted into a dewatered form that retains the functionality of the functional ingredient, and that renders the functional ingredient composition suitable for inclusion in a compressed tablet composition.

Provided are methods for removing water from an aqueous functional ingredient composition containing more than 10 wt % water, the method comprising mixing in a mixer a solid base, a polyester solvent, and the aqueous functional ingredient composition at room temperature to produce a dewatered product, wherein the amount of water in the dewatered product is no more than 33% of a starting amount of the water in the aqueous functional ingredient composition, and a difference between a total weight of the solid base, the polyester solvent, and the aqueous functional ingredient composition added to the mixer and a final weight of the dewatered product is 2% or less. A functional ingredient in the aqueous functional ingredient composition can be or include a surfactant, a dispersant, an anti-redeposition agent, a solubility modifier, a rinse aid, an odor counteractant, a chelating agent, a conditioning agent, an anti-static agent, a soil shielding agent, a soil releasing agent, a color protection agent, or a combination thereof. The starting amount of water in the aqueous functional ingredient composition can be in a range of 10 wt % to 98 wt %.

The solid base can include an alkaline material that is solid at room temperature and that has a pH in the range of about 8 to 13.5. The solid base can include an alkali metal salt, an alkaline-earth metal salt, an aminopolycarboxylate-based chelating agent, a tetrasodium iminodisuccinate complexing agent, or combinations thereof. The solid base can include one or more selected from the group consisting of sodium acetate, potassium acetate, sodium carbonate, potassium carbonate, calcium carbonate, magnesium carbonate, sodium bicarbonate, potassium bicarbonate, sodium sesquicarbonate, sodium silicate, potassium silicate, sodium metasilicate, potassium meta silicate, methylglycine N,N-diacetic acid trisodium salt (MGDA), glutamate diacetate tetrasodium salt (GLDA), and tetrasodium iminodisuccinate. The solid base can include a sodium carbonate, a sodium bicarbonate, a potassium carbonate, a potassium bicarbonate, MGDA, GLDA, or a combination thereof.

In the methods provided herein, the polyester solvent can include an ester compound that includes three or more

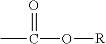

moieties. The polyester solvent can be or include a citric acid ester, a lactic acid ester, a glyceryl ester, or a combination thereof. The polyester solvent can include triethyl citrate, acetyltriethyl citrate, tributyl citrate, acetyltributyl citrate, trihexyl citrate, n-butyryl-tri (n-hexyl)-citrate, trioctyl citrate, tributyl aconitate, glycerol triacetate (triacetin), glycerol tripropanoate (tripropionin), glyceryl tributyrate (tributyrin), glycerol tricaprate (tricaprin), glyceryl trioleate (triolein), glyceryl tristearate (stearin), glyceryl tripalmitate (tripalmitin), pentaerythrityl tetraethylhexanoate, or a combination thereof. The polyester solvent can be selected from among triethyl citrate, acetyltriethyl citrate, tributyl citrate, acetyltributyl citrate, glycerol triacetate (triacetin), glycerol tripropanoate (tripropionin), glyceryl tributyrate (tributyrin), and combinations thereof.

In the methods provided herein, when the ratio of the solid base to the functional ingredient composition is in a range of about 5:1 to 15:1, the dewatered product is in a form of a flowable powder. When the ratio of the solid base to the functional ingredient composition is in a range of about 5:1 to 15:1, a ratio of the solid base to the polyester solvent can be in a range of about 3:1 to 8.5:1. When the ratio of the solid base to the functional ingredient composition is in a range of about 5:1 to 15:1, a ratio of the polyester solvent to the functional ingredient composition can be in a range of about 1:1 to 3:1.

In the methods provided herein, when the ratio of the solid base to the functional ingredient composition is in a range of about 3:1 to 1:5, the dewatered product is in a form of a viscous fluid. When the ratio of the solid base to the functional ingredient composition is in a range of about 3:1 to 1:5, a ratio of the solid base to the polyester solvent is in a range of about 3.5:1 to 1:11. When the ratio of the solid base to the functional ingredient composition is in a range of about 3:1 to 1:5, a ratio of the polyester solvent to the functional ingredient composition is in a range of about 4:1 to 1:4.

In the methods provided herein, when the ratio of the solid base to the functional ingredient composition is in a range of about 3:1 to 1:5, the dewatered product can be allowed to age for a time period of 3 hours to 8 hours resulting in a dewatered product in a form of a gel. The dewatered product can be allowed to age for a time period of 18 hours to 24 hours resulting in a dewatered product in a form of a putty.

The dewatered product, in the form of a viscous fluid, or gel, or putty, can be blended with a flow aid to yield a flowable product. The flow aid can include a) sodium chloride, potassium chloride sodium sulfate, potassium sulfate, or a combination thereof; b) a sodium and/or a potassium salt of at least one of an acetate, carbonate, bicarbonate, citrate, phosphate, silicate, aluminate, or a combination thereof; or c) a combination of these materials. A ratio of the flow aid to the dewatered product can be from about 1:1 to 5:1. The blending of the dewatered product in the form of a viscous fluid or gel with the flow aid can be performed for a time of about 10 minutes or more. The time period can be from 10 minutes to 120 minutes, or 10 minutes to 60 minutes. In some methods, the dewatered product is allowed to age for a time period of 1 hour to 24 hours prior to blending with the flow aid.

In some methods provided herein, when the dewatered product is allowed to age for 18 to 24 hours and the resulting dewatered product has a consistency of a hard putty, and the dewatered product can be converted into a flowable powder by application of energy alone to comminute the aged product into small particles without the need of adding a flow-aid.

In the methods provided herein, the mixer used in mixing the solid base, the polyester solvent, and the aqueous functional ingredient composition can be any mixer known in the art. The mixer can be a KitchenAid® countertop stand mixer, a Hobart® planetary mixer, a vee-blender, a vee-cone blender, a rotary batch mixer, a ribbon blender, a paddle blender, a plow blender, a screw mixer, a turbulizer, a Nauta® mixer, a double arm kneader mixer, or a combinations thereof. The mixing can be carried out at room temperature under atmospheric pressure. The mixing can be performed for a period of at least 10 minutes. The mixing can be performed for a period of 10 to 120 minutes, or a period of 10 to 60 minutes. The amount of water in the dewatered product is no more than about 33% of a starting amount of the water in the aqueous functional ingredient composition.

Also provide is a dewatered product produced by the methods provided herein. Also provided are compositions that contain the dewatered product produced by the methods provided herein. The composition can be in the form or a compressed tablet.

An amount of the dewatered product in the composition or compressed tablet can be in a range of about 5 wt % to 95 wt % based on a total weight of the composition or the compressed tablet. The composition or compressed tablet can further include an additional component in a range of about 0.05 wt % to 75 wt %, based on a total weight of the composition. The additional component can be selected from among an organic solvent, an additional surfactant, a buffering salt, a lubricant, a fragrance, a colorant, a chelant, an enzyme, an acid, a carbonate, a bicarbonate, a phosphate, a wetting agent, a dispersing agent, a hydrotrope, an effervescent generator, a rheology control agent, a foam suppressant, and a combination thereof. The composition or compressed tablet can be formulated to produce a sanitizing product, a disinfecting product, a surface cleaner, a hand wash product, a body wash product, a hair wash product, a hair conditioning product, a skin softening product, a dish soap or detergent product, a laundry detergent, a laundry softening product, a laundry anti-static product, or a pet odor removal product.

Also provided are unit dosage forms that include the dewatered product produced by the methods provided herein. The unit dosage form can be in the form of a compressed tablet, capsule, pellet, puck, brick, briquette, block, dissolvable pouch, dissolvable packet. When dissolved in a solvent, one or more unit dosage forms can yield a sanitizing solution, a disinfecting solution, a surface cleaner, a hand wash product, a body wash product, a hair wash product, a hair conditioning product, a skin softening product, a dish soap or detergent product, a laundry detergent, a laundry softening product, a laundry anti-static product, or a pet odor removal product.

### DETAILED DESCRIPTION

### A. Definitions

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet. Reference thereto evidences the availability and public dissemination of such information.

As used herein, the singular forms “a,” “an” and “the” include plural referents unless the context clearly dictates otherwise.

As used herein, all ranges include the upper and lower limits. As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 3, 4-8, 2.15, 6.8-9.1, etc.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values associated therewith. Hence “about 5 percent” means “about 5 percent” and also “5 percent.”

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, the terms “comprises” and “comprising” are inclusive and open ended, and not exclusive. When used in the specification and claims, the terms “comprises” and “comprising” and variations thereof mean the specified features, steps or components are included, but do not exclude other features, steps or components.

Any compositions described herein are intended to encompass compositions which consist of, consist essentially of, as well as comprise, the various constituents identified herein, unless explicitly indicated to the contrary.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

As used herein, the term “exemplary” means “serving as an example or illustration,” and should not be construed as being preferred or advantageous over other configurations disclosed herein.

Unless indicated otherwise, each of the individual features or embodiments of the present specification are combinable with any other individual feature or embodiment that are described herein, without limitation. Such combinations are specifically contemplated as being within the scope of the present invention, regardless of whether they are explicitly described as a combination herein.

As used herein, “weight percent” or “wt %” refers to the concentration of a substance as the weight of that substance divided by the total weight of the composition and multiplied by 100.

As used herein, “functional ingredient composition” refers to a composition that includes a compound or ingredient that performs or fulfills a specific function within a product to deliver or produce a beneficial effect. Exemplary functional ingredient compositions include surfactants, dispersants, anti-redeposition agents, solubility modifiers, rinse aids, odor counteractants, chelating agents, conditioning agents, anti-static agents, soil shielding agents, soil releasing agents, and color protection agents.

As used herein, “water removal” means converting at least a portion of the water in a composition into other more desirable products, and therefore results in negligible loss of total weight of the total weight of the starting ingredients.

As used herein, a “compressed tablet” refers to a dosage form comprising a compressed powder. For example, a compressed tablet can be formed using a rotary tablet press or other similar machinery known to one of skill in the art.

As used herein, “surfactant” refers to surface active molecules that absorb at the air/water, oil/water and/or oil/water interfaces, substantially reducing their surface energy. Surfactants generally are classified depending on the charge of the surface active moiety, and can be categorized as cationic, anionic, nonionic and amphoteric surfactants.

As used herein, a “biosurfactant” is a surface-active agent of biological origin.

As used herein, a “composite” refers to a mixture of two or more different ingredients in which the ingredients do not dissolve or merge completely, but which forms a substantially homogeneous material (i.e., a material without laminate structure or a composition gradient).

As used herein, “eco-friendly” means not harmful to, or having minimal negative impact on, the environment.

As used herein, a “solid” refers to a composition that is not a fluid or liquid, and that substantially retains its shape under moderate stress, pressure or gravity.

As used herein, “flowable” refers to the ability of a material to flow under its own weight at a given temperature, or a material that can move in a stream in response to an external force imposed on it.

As used herein, a “granulate” refers to an aggregate of particles.

As used herein, a “powder” refers to a solid composed of granular materials such as particles or granulates or a combination thereof, and can flow freely under moderate stress (such as mixing) or gravity.

As used herein, a “dewatered product” refers to a resulting material that contains less water than the starting material used.

As used herein, a “flow aid” refers to a substance that when blended with the dewatered product helps to disperse the dewatered product into particles that can flow freely.

As used herein, a “viscous liquid” refers to a material that exhibits relatively high viscosity while maintaining fluidity, and has a thick consistency, somewhere between water, which has a low viscosity, and a gel.

As used herein, a “gel” refers to a flowable jelly-like material, generally having the consistency of petroleum jelly or toothpaste.

As used herein, a “putty” refers to a composition having a dough-like or clay-like texture, which can have varying degrees of firmness (resistance to deformation). A “very soft putty” is easily deformable, and has a consistency similar to bread dough. A “soft putty” requires the application of minimal force to deform, and has the constituency of a pomade or balm. A “normal putty” has the consistency of “Silly Putty” (an “elastic solid” that is a mixture that includes dimethylsiloxane, silica, polydimethylsiloxane, glycerine, decamethyl cyclopentasiloxane, and a castor oil derivative) or Play-Doh (a soft, pliable modeling compound) and is deformable with moderate force. A “hard putty” is not easily deformed and requires the application of a moderately high force in order to deform. A “very hard putty” requires the application of a high degree of force in order to deform, having the consistency of a waxy solid, such as a carnauba paste car wax like Turtle Wax®.

As used herein, “room temperature” means an ambient temperature in the range of from about 20° C. to about 25° C. (generally having an average of about 21° C.).

As used herein, a “room temperature process” means the process is performed at ambient temperature and no thermal energy is added, although frictional heating due to mixing, or an increase in temperature due to a chemical reaction, such as hydrolysis, may occur.

### B. Description of the Drawings

FIG. 1 is a second derivative near infrared spectrum of a dewatered product produced by the methods provided herein. The dewatered product was scanned on a Metrohm/Foss Near Infrared Spectroscopy system.

FIG. 2A through FIG. 6B are graphs showing the bivariate fit of the reduction of intensity (‘Y’) of the water peaks (1400 nm and 1900 nm) separately, which correlates to the reduction of the amount of water molecules in the blends. The x-axis shows the time of measurement. FIGS. 2A and 2B show the results obtained for Mix 1 (Plantapon® LGC Sorb surfactant) at 1400 nm and 1900 nm, respectively. FIGS. 3A and 3B show the results obtained for Mix 2 (Crodasinic® LS30 surfactant) at 1400 nm and 1900 nm, respectively. FIGS. 4A and 4B show the results obtained for Mix 3 (Hostapon CGN surfactant) at 1400 nm and 1900 nm, respectively. FIGS. 5A and 5B shows the results obtained for Mix 4 (ColaTeric® BOB surfactant with soda ash) at 1400 nm and 1900 nm, respectively. FIGS. 6A and 6B shows the results obtained for Mix 5 (ColaTeric® BOB surfactant with Trilon® M) at 1400 nm and 1900 nm, respectively.

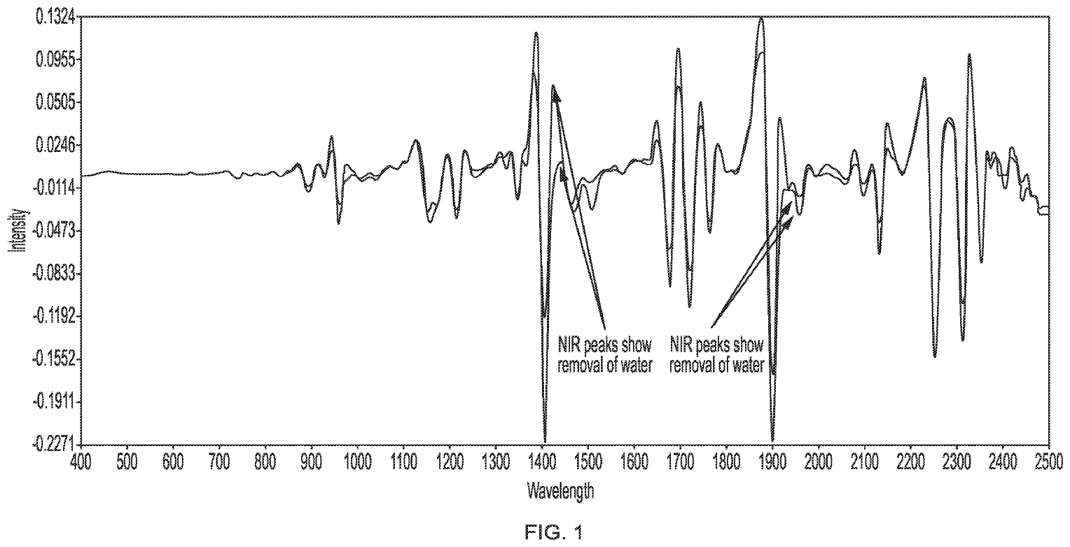

### C. Description of the Methods Provided Herein

Many functional ingredients having desirable properties, such as surfactants, deodorants, etc. are not available in a water-free form. For example, many surfactant compositions can contain 30-70 wt % as provided by their manufacturers, and are not available in a dry form. These water-containing surfactant compositions represent approximately 30% to 40% of surfactant compositions options currently available. The presence of water can preclude their use in some formulations, such as solid granular or tableted products, unless the water present in the functional ingredient composition as-delivered is removed. Some other functional ingredients can be provided by their manufacturer in a form that can include 98 to 99 wt % water. With such high water content, these functional ingredient compositions typically cannot be included in formulations, such as solid granular or tableted products, unless the water present in the functional ingredient composition as-delivered is removed.

Provided herein are eco-friendly, environmentally acceptable, economical, and efficient methods for modifying a functional ingredient composition that contains 10 wt % or more water so that the functional ingredient composition can be converted into a stable dewatered product form that retains the functionality of the functional ingredient, and that renders the functional ingredient composition suitable for inclusion in a compressed tablet composition.

The methods provided herein do not require long periods of time to effect water reduction, or require large energy inputs to reduce the amount of water present, or heating units, or any specialty pieces of equipment to perform the method. The methods can be performed using mixing equipment typically present at a formulation manufacturer's production site.

In addition, the methods provided herein do not result in loss of active ingredient during processing, unlike traditional heating or distillation processes commonly used for water removal from ingredient compositions. The traditional methods depend on the removal of water using energy-intensive methods, typically by heating or distilling, and thus a decrease in the overall weight of product obtained at the end of the water removal process. In contrast, the methods provided herein convert at least a portion of the water present in a water-containing active ingredient composition into beneficial ingredients, and therefore the change in weight of the final product compared to the weight of the starting materials is minimal.

In the methods provided herein, the functional ingredient in the functional ingredient composition as-provided is not subjected to high temperatures to evaporate or distill away the water. Instead, a process is provided that is performed under ambient conditions (typically room temperature and pressure (about 1 atmosphere, or about 1 bar, or about 14.7 psi)). The process includes a chemical reaction that allows for the conversion of water under thermodynamically favorable conditions so that no thermal energy input is required to drive the reaction. Frictional heating during mixing, or a chemical reaction during the method, or both, can result in an increase in temperature, but no additional thermal energy input is required for the method. For example, addition of water from the functional ingredient composition to a sodium carbonate or potassium carbonate can result in an increase in temperature, such as up to 40 to 70° C.

The methods provided herein can remove water from a functional ingredient composition containing 10 wt % water or more (such as from 10 wt % to 98 wt %) resulting in a dewatered product. The method comprises mixing in a mixer a solid base having a pH in the range of 8 to 13, a polyester solvent, and the functional ingredient composition. The mixing can be performed at room temperature and ambient pressure. The mixing can be done for a period of 10 to 60 minutes. In some methods, the resulting dewatered product is in a form of a flowable powder. In some methods, the resulting dewatered product is in a form of a viscous fluid or gel, which can be converted into a flowable powder by mixing with a salt. In some embodiments, the salt can be or contain a neutral salt, such a sodium chloride, potassium chloride sodium sulfate, or potassium sulfate, or combinations thereof. In some embodiments, the salt can be or contain a sodium and/or potassium salt of at least one of an acetate, carbonate, bicarbonate, citrate, phosphate, silicate or aluminate, or combinations thereof.

In the methods provided, an ester hydrolysis reaction consumes at least a portion of the water present in the active ingredient, and creates safe by-products, such as glycerin or ethanol, that can be beneficial, particularly for compressed tablet production.

An exemplary reaction scheme of the methods provided herein is shown in Reaction Scheme 1 below.

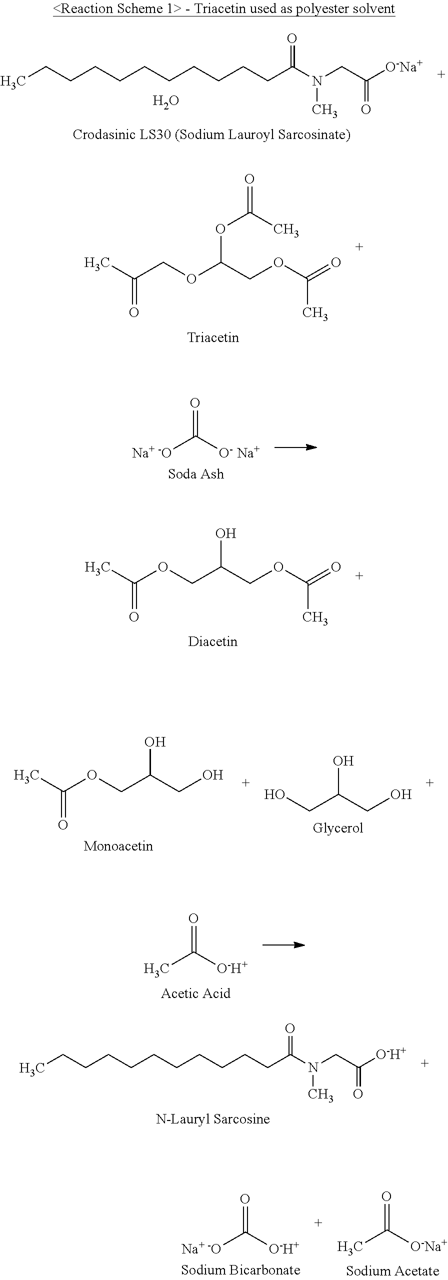

In the reaction shown in Reaction Scheme 1, an aqueous surfactant composition (Crodasinic™ LS30, an aqueous composition containing sodium lauroyl sarcosinate) is mixed with triacetin (glyceryl triacetate) as a polyester solvent and soda ash (sodium carbonate (Na₂CO₃)) as the solid base. A hydrolytic reaction occurs, resulting in the production of diacetin, monoacetin, glycerol, and acetic acid, which undergo ion exchange between the sodium lauroyl sarcosinate, soda ash, and acetic acid to yield, inter alia, N-lauryl sarcosine, sodium bicarbonate, sodium acetate, and glycerol. Little to no water remains.

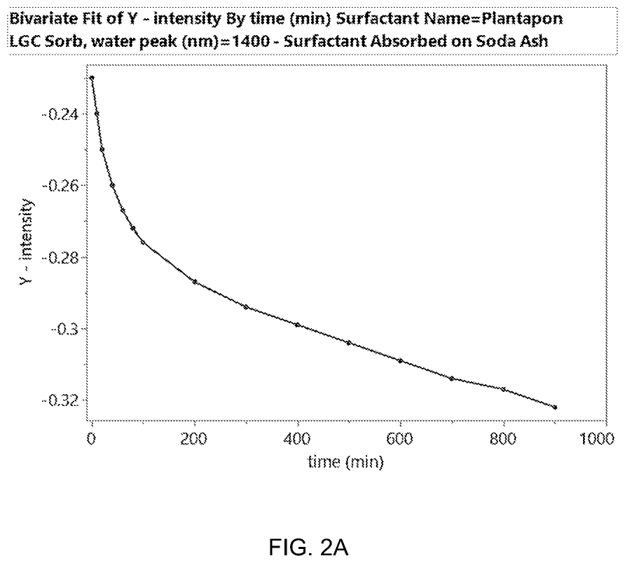

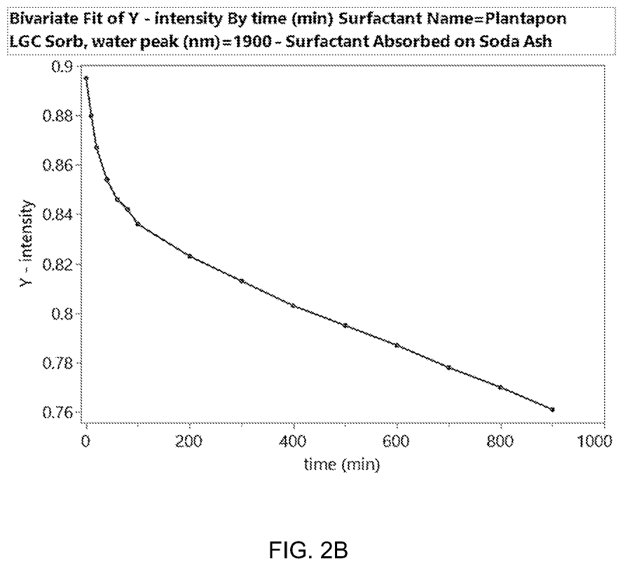

The reduction or disappearance of water can be evaluated using any technique known in the art. For example, Near Infrared Spectroscopy (NIRS) can be used. Peaks for water appear around 1400-1450 and 1900-1950 nm in the near infrared spectrum. The dewatered product produced using the method provided herein was scanned on a Metrohm/Foss Near Infrared Spectroscopy system immediately after mixing, and 24 hours after storage. As can be seen in FIG. 2, the amount of water present in the dewatered product at the end of the reaction of the methods provided herein is significantly reduced. The spectrum shown in FIG. 2 is a second derivative spectrum used to characterize the dewatered products.

A method using a different polyester solvent is shown in Reaction Scheme 2. In Reaction Scheme 2, triethyl citrate (Citrofol® Al) was used as the polyester solvent.

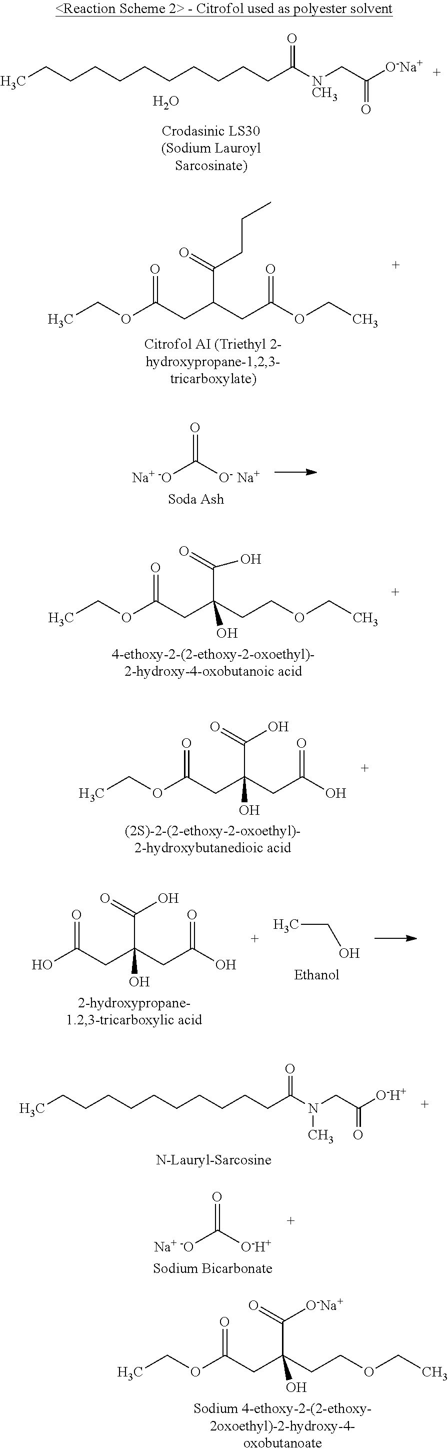

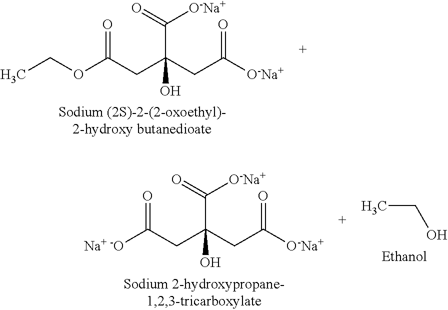

In the reaction shown in Reaction Scheme 2, an aqueous surfactant composition (Crodasinic™ LS30, an aqueous composition containing sodium lauroyl sarcosinate) is mixed with Citrofol® Al (triethyl 2-hydroxypropane-1,2,3-tricarboxylate or triethyl citrate) as a polyester solvent and soda ash (sodium carbonate (Na₂CO₃)) as the solid base. A hydrolytic reaction occurs, resulting in the production of sodium 4-ethoxy-2-(2-ethoxy-oxoethyl)-2-hydroxy-4-oxobutanoate, sodium (2S)-2-(2-oxoethyl)-2-hydroxy-butanedioate, sodium 2-hydroxypropane-1,2,3-tricarboxylate, sodium bicarbonate, and ethanol, which undergo ion exchange to yield, inter alia, N-lauryl sarcosine, sodium bicarbonate, sodium citrate, and ethanol. Little to no water remains.

In the methods provided herein, safe starting materials are used, and the reaction results in the production of safe products.

### Solid Base

The methods provided herein include mixing a solid base with a polyester solvent and the functional ingredient composition. The solid base used in the methods can be any alkaline material that is solid at room temperature and that has a pH in the range of about 8 to 13.5. In some embodiments, the solid base can have a pH in the range of about 8.3 to 12.5. In some embodiments, the solid base can have a pH in the range of about 9 to 12. In some embodiments, the solid base can have a pH in the range of about 10.5 to 12.

The solid base can include an alkali metal salt, an alkaline-earth metal salt, an aminopolycarboxylate-based chelating agent, a tetrasodium iminodisuccinate complexing agent, or combinations thereof. Some examples of alkali metal salts include alkali metal acetates, bicarbonates, carbonates, citrates, silicates, metasilicates, and mixtures thereof. Some examples of alkaline-earth metal salts include alkaline-earth metal acetates, bicarbonates, carbonates, citrates, silicates, metasilicates, and mixtures thereof. Exemplary solid bases include, but are not limited to, potassium acetate, sodium acetate, sodium carbonate, potassium carbonate, calcium carbonate, magnesium carbonate, sodium bicarbonate, potassium bicarbonate, sodium sesquicarbonate, sodium citrate, potassium citrate, sodium silicate, potassium silicate, sodium metasilicate, potassium metasilicate, methylglycine N,N-diacetic acid trisodium salt (MGDA, such as Dissolvine® M-S, Nouryon, Arnhem, the Netherlands), glutamate diacetate tetrasodium salt (N,N-dicarboxymethyl glutamic acid tetrasodium salt (GLDA, such as Dissolvine® GL-PD-S, Nouryon, Arnhem, the Netherlands), tetrasodium iminodisuccinate such as Baypure® CX100 solid G (RheinChemie Additives, Koln, Germany) and combinations thereof. In some embodiments, the solid base is a sodium carbonate, a sodium bicarbonate, a potassium carbonate, a potassium bicarbonate, MGDA, GLDA, or a combination thereof.

### Polyester Solvent

The polyester solvent can be any ester compound that includes three or more

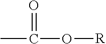

moieties. In some embodiments, the polyester solvent can include a citric acid ester, a lactic acid ester, or combinations thereof. In some embodiments, the polyester solvent can include a glyceryl ester. In some embodiments, the polyester solvent can include a glyceryl ester, a citric acid ester, or a combination thereof.

Exemplary polyester solvents include, but are not limited to, triethyl citrate (Citrofol® Al, Jungbunzlauer), acetyltriethyl citrate (Citrofol® All), tributyl citrate (Citrofol® BI, Jungbunzlauer), acetyltributyl citrate (Citrofol® B11), trihexyl citrate, n-butyryl-tri (n-hexyl)-citrate, trioctyl citrate, tributyl aconitate, glycerol triacetate (triacetin), glycerol tripropanoate (tripropionin), glyceryl tributyrate (tributyrin), glycerol tricaprate (tricaprin), glyceryl trioleate (triolein). glyceryl tristearate (stearin), glyceryl tripalmitate (tripalmitin), pentaerythrityl tetraethylhexanoate, and combinations thereof. In some embodiments, the polyester solvent can be selected from among triethyl citrate, acetyltriethyl citrate, tributyl citrate, acetyltributyl citrate, glycerol triacetate (triacetin), glycerol tripropanoate (tripropionin), glyceryl tributyrate (tributyrin), and combinations thereof.

### Functional Ingredient Composition

Any functional ingredient composition that includes 10 wt % or more of water can be selected for removal of water in the functional ingredient composition using the methods provided herein. Exemplary functional ingredient compositions include, but are not limited to, surfactants, dispersants, anti-redeposition agents, solubility modifiers, rinse aids, odor counteractants, chelating agents, conditioning agents, anti-static agents, soil shielding agents, soil releasing agents, and color protection agents.

When the functional ingredient composition includes a surfactant, the surfactant can be selected from among a cationic surfactant, an anionic surfactant, a non-ionic surfactant, a zwitterionic surfactant, a silicone surfactant, a biosurfactant, and a combination thereof.

Exemplary non-ionic surfactants include a nonylphenol ethoxylate surfactant, nonylphenoxypoly(ethyleneoxy) ethanol; nonylphenyl polyethyleneglycol ether, nonionic; polyoxyethylene (10) nonylphenol; polyoxyethylene (14) nonylphenol; polyoxyethylene (1.5) nonyl phenol; polyoxyethylene (20) nonylphenol; polyoxyethylene (30) nonylphenol; polyoxyethylene (4) nonylphenol; polyoxyethylene (5) nonylphenol; polyoxyethylene (6) nonylphenol; polyoxyethylene (8) nonylphenol; polyoxyethylene (9) nonylphenyl ether; Protachem 630; Sterox; Surfionic N; T-DET-N; Tergitol NP; Tergitol NP-14; Tergitol NP-27; Tergitol NP-33; Tergitol NP-35; Tergitol NP-40; Tergitol NPX; Tergitol TP-9; Triton N; Triton X; Dowfax 9N; ethoxylated nonylphenol; Igepal CO; Igepal CO-630; macrogol nonylphenyl ether; Makon; Neutronyx 600; Nonipol NO; nonionic surfactants having a polyalkylene oxide polymer as a portion of the surfactant molecule, such as chlorine-, benzyl-, methyl-, ethyl-, propyl-, butyl- and other similar alkyl-capped polyethylene glycol ethers of fatty alcohols; polyalkylene oxide free non-ionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates; nonylphenol ethoxylate, polyoxyethylene glycol ethers; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and polyalkylene oxide block copolymers including an ethylene oxide/propylene oxide block copolymer such as those commercially available under the trademark PLURONIC® (BASF-Wyandotte).

Exemplary silicone surfactants that can be present in the functional ingredient compositions include, but are not limited to, dimethicone copolyols and alkyl dimethicone copolyols and blends thereof, a polyalkyl polyether polysiloxane copolymer having an alkyl radical containing from 5 to 22 carbon atoms, such as cetyl dimethicone copolyol, such as that sold under the name Abil® EM-90 by Evonik Industries AG (Essen, Germany), the mixture of dimethicone copolyol and cyclopentasiloxane (85/15), such as that sold under the name Abil® EM-97 by Goldschmidt, linear-type polyether-modified silicone emulsifiers, including methyl ether dimethicones, such as PEG-3 methyl ether dimethicones, PEG-9 methyl ether dimethicones, PEG-10 methyl ether dimethicones, PEG-11 methyl ether dimethicones, and butyl ether dimethicones (available from Shin-Etsu (Akron, Ohio); branched-type polyether-modified silicone emulsifiers, such as PEG-9 polydimethylsiloxyetheyl dimethicone (Shin-Etsu), alkyl co-modified branched-type polyether silicones, such as lauryl PEG-9 polydimethyl-siloxyethyl dimethicone (Shin-Etsu), silicones containing polyalkylene oxide groups, such as the commercially available emulsifier Silwet® 7001, manufactured by Momentive Performance Materials (Albany, NY), Dow Corning FG-10, Silwet® L-77 (polyalkylene oxide modified heptamethyl trisiloxane containing a methyl end group and 1 pendant group and having an average molecular weight of 645) and Silwet® L-7608 (polyalkylene oxide modified heptamethyl trisiloxane containing a hydrogen end group and one pendant group and having an average molecular weight of 630) available from Momentive Performance Materials; Lambent™ MFF-199-SW (containing a hydrogen end group and one pendant polyethylene oxide group and having an average molecular weight between 600 to 1000) available from Lambent Technologies Inc. (Gurnee, Illinois); silicone copolyol based carboxylate esters, such as SW-CP-K (containing a phthalate end group and one polyethylene oxide pendant group and having an average molecular weight between 800 and 1100) and Lube CPI (containing a phthalic acid end group and 3 to 5 pendant groups and having an average molecular weight between 2900 and 5300) available from Lambent Technologies Inc.; alkyl-dimethicone copolyol type surfactants, such as described in U.S. Pat. No. 7,083,800 (Terren et al, 2006), including such silicone emulsifiers commercially sold under the names “Abil® WE 09”, “Abil® WS 08” and “Abil® EM 90” (Evonik Industries AG, Essen, Germany) and cationic silicone emulsifiers, such as described in U.S. Pat. No. 5,124,466 (Azechi et al., 1992).

Exemplary cationic surfactants include but are not limited to homopolymers and copolymers derived from free radically polymerizable acrylic or methacrylic ester or amide monomers. The copolymers can contain one or more units derived from acrylamides, methacrylamides, diacetone acrylamides, acrylic or methacrylic acids or their esters, vinyl lactams such as vinyl pyrrolidone or vinyl caprolactam, and vinyl esters. Exemplary polymers include copolymers of acrylamide and dimethyl amino ethyl methacrylate quaternized with dimethyl sulfate or with an alkyl halide; copolymers of acrylamide and methacryloyl oxyethyl trimethyl ammonium chloride; the copolymer of acrylamide and methacryloyl oxyethyl trimethyl ammonium methosulfate; copolymers of vinyl pyrrolidone/dialkylaminoalkyl acrylate or methacrylate, optionally quaternized, such as the products sold under the name GAFQUAT™ by International Specialty Products; the dimethyl amino ethyl methacrylate/vinyl caprolactam/vinyl pyrrolidone terpolymers, such as the product sold under the name GAFFIX™ VC 713 by International Specialty Products; the vinyl pyrrolidone/methacrylamidopropyl dimethylamine copolymer, marketed under the name STYLEZE™ CC 10 by International Specialty Products; and the vinyl pyrrolidone and quaternized dimethyl amino propyl methacrylamide copolymers such as the product sold under the name GAFQUAT™ HS 100 by International Specialty Products; quaternary polymers of vinyl pyrrolidone and vinyl imidazole such as the products sold under the trade name Luviquat® (product designation FC 905, FC 550, and FC 370) by BASF; acetamidopropyl trimonium chloride, behenamidopropyl dimethylamine, behenamidopropyl ethyldimonium ethosulfate, behentrimonium chloride, cetethyl morpholinium ethosulfate, cetrimonium chloride, cocoamidopropyl ethyl-dimonium ethosulfate, dicetyldimonium chloride, dimethicone hydroxypropyl trimonium chloride, hydroxyethyl behenamidopropyl diammonium chloride, quaternium-26, quaternium-27, quaternium-53, quaternium-63, quaternium-70, quaternium-72, quaternium-76 hydrolyzed collagen, PPG-9 diethylammonium chloride, PPG-25 diethylammonium chloride, PPG-40 diethylmonium chloride, stearalkonium chloride, stearamidopropyl ethyl dimonium ethosulfate, steardimonium hydroxypropyl hydrolyzed wheat protein, steardimonium hydroxypropyl hydrolyzed collagen, wheat germamido-propalkonium chloride, wheat germamidopropyl ethyldimonium ethosulfate, polymers and copolymers of dimethyl diallyl ammonium chloride, such as Polyquaternium-4, Polyquaternium-6, Polyquaternium-7, Polyquaternium-10, Polyquaternium-11, Polyquarternium-16, Polyquaternium-22, Polyquaternium-24, Polyquaternium-28, Polyquaternium-29, Polyquaternium-32, Polyquaternium-33, Polyquaternium-35, Polyquaternium-37, Polyquaternium-39, Polyquaternium-44, Polyquaternium-46, Polyquaternium-47, Polyquaternium-52, Polyquaternium-53, Polyquarternium-55, Polyquaternium-59, Polyquaternium-61, Polyquaternium-64, Polyquaternium-65, Polyquaternium-67, Polyquaternium-69, Polyquaternium-70, Polyquaternium-71, Polyquaternium-72, Polyquaternium-73, Polyquaternium-74, Polyquaternium-76, Polyquaternium-77, Polyquaternium-78, Polyquaternium-79, Polyquaternium-80, Polyquaternium-81, Polyquaternium-82, Polyquaternium-84, Polyquaternium-85, Polyquaternium-87, PEG-2-cocomonium chloride, and mixtures thereof; polyalkyleneimines such as polyethyleneimines, polymers containing vinyl pyridine or vinyl pyridinium units, condensates of polyamines and epichlorhydrins; quaternary polyurethanes; salts of a primary, secondary, or tertiary fatty amine, optionally polyoxyalkylenated; a quaternary ammonium salt derivative of imidazoline, or an amine oxide; mono-, di-, or tri-alkyl quaternary ammonium compounds with a counterion such as a chloride, methosulfate, tosylate, including, but not limited to, cetrimonium chloride, dicetyidimonium chloride and behentrimonium methosulfate.

Exemplary anionic surfactants include, but are not limited to, one or more of a carboxylate such as, without limitation, alkylcarboxylates (e.g., carboxylic acid and/or its salts), polyalkoxycarboxylates (e.g., polycarboxylic acid and/or its salts), alcohol ethoxylate carboxylates, nonylphenol ethoxylate carboxylates, or combinations thereof; sulfonates such as, without limitation, alkylsulfonates, alkylbenzenesulfonates (e.g., dodecyl benzene sulfonic acid and/or its salts), alkylarylsulfonates, sulfonated fatty acid esters, or combinations thereof; sulfates such as, without limitation, sulfated alcohols, sulfated alcohol ethoxylates, sulfated alkylphenols, alkylsulfates, sulfosuccinates, alkylether sulfates, or combinations thereof; phosphate esters such as, without limitation, alkyl-phosphate esters; or combinations thereof. Exemplary anionic surfactants include sodium alkylarylsulfonate, alpha-olefinsulfonate, fatty alcohol sulfates and combinations thereof. Exemplary sulfosuccinates include alkyl sulfosuccinates and amido sulfosuccinates, such as disodium lauryl sulfosuccinate (CAS 26838 May 1), disodium laureth sulfosuccinate (CAS No. 39354-45-5), disodium oleamido MIPA sulfosuccinate (CAS No. 67815-88-7), and combinations thereof.

Exemplary amphoteric surfactants (or zwitterionic surfactants) include, but are not limited to, imidazoline derivatives, betaines, imidazolines, sultaines, propionates, amine oxides or combinations thereof, including imidazolinium betaine, dimethylalkyl lauryl betaine, alkylglycine, and alkyldi (aminoethyl)glycine. The betaines can be an alkyl betaine, an alkylamido betaine, or a mixture thereof, such as any one of cetyl betaine (CAS No. 693-33-4), lauryl betaine (CAS No. 683-10-3), cocamidopropyl betaine (CAS No. 61789-40-0), lauramidopropyl betaine (CAS No. 4292-10-8), or a combination thereof.

The functional ingredient composition can include a surfactant that includes a linear alcohol ethoxylate (e.g., Tomadol® 25-7, available from Evonik Industries AG, Essen, Germany), or a C11 alcohol ethoxylate 5 E.O. (e.g., Tomadol® 1-5, Evonik), or a C11 alcohol ethoxylate 7 E.O. (e.g., Tomadol® 1-7, Evonik), or a C11 alcohol ethoxylate 9 E.O. (e.g., Tomadol® 1-9, Evonik), or sodium lauryl sulfate, or a sodium dodecyl benzene sulfonate (e.g., available from Stepan Company, Northfield, IL), or a C9-C11 alcohol ethoxylate (e.g., Tomadol® 91-6, Evonik), or a C12-C18 alcohol ethoxylate (e.g., available from Croda Inc., Mill Hall, PA), or PEG 7 glyceryl cocoate, or a sodium lauroyl sarcosinate (e.g., Perlastan® L30 available from Schill and Seilacher GmbH, Boeblingen, Germany), or any combination thereof. The surfactant can include 2-butenedioic acid-1-dodecyl ester (CAS No. 2424-61-5), sodium 2-sulfo-butanedioic acid (CAS No. 13419-59-5), sodium lauroyl sarcosinate (CAS No. 137-16-6), sodium cocoyl sarcosinate (CAS No. 61791-59-1), or a combination thereof.

The functional ingredient composition can include a biosurfactant. The biosurfactant can be a polymeric biosurfactant, a glycolipid, a lipopeptide, a lipoprotein, a phospholipid, a flavolipid, or a combination thereof. The biosurfactant can be a lecithin, a saponin, a rhamnolipid, a sophorolipid, a mannosylerythritol lipid, a marine alga glycolipid, a glucose lipid, a cellulose lipid, a trehalose lipid, a glucoside, an alkyl glucoside, an alkyl polyglucoside, a cellobiose lipid, a polyol lipid, a protein polyamine, a lipopolysaccharide, fengycin, iturin, lichenysin, surfactin, or a combination thereof.

Exemplary functional ingredient compositions include, but are not limited to, Crodateric™ CAB30 (cocamidopropyl betaine and water, Croda Inc., Chino Hills, CA), Crodasinic™ LS30 (sodium lauroyl sarcosinate and water, Croda Inc., Chino Hills, CA), Crodasinic™ CS30 (sodium cocoyl sarcosinate and water, Croda Inc., Chino Hills, CA), Plantaren® 818UP (coco-glucoside and water, BASF Care Creations, San Bruno, CA), AlphaStep® PC48 (sodium methyl 2-Sulfolaurate, Disodium 2-Sulfolaurate and water, Stepan Company, Northbrook, IL), Cola®Teric BOB (babassu-amido-propyl betaine, Colonial Chemical Inc., Pittsburgh, TN), Glucopon® 420UP (C8-C16 alkyl polyglucosides (caprylyl/myristyl glucoside) and water, BASF Care Creations, San Bruno, CA), Amphi™ M (lactonic sophorolipid CAS No. 1573124-58-9 and water, Locus Performance Ingredients, Richmond, VA), MultiTrope™ 810 (anionic surfactant and water, Croda Inc., Chino Hills, CA), Zinador™ 22L (polymeric zinc itaconate complex odor neutralizer and water, Croda Inc., Chino Hills, CA), Zinador™ 35L (polymeric zinc itaconate complex odor neutralizer and water, Croda Inc., Chino Hills, CA), and Carboxyline® 25-40 D (sodium carboxymethyl inulin and water, Cosun Beet Company, San Jose, CA).

In the methods provided herein, the starting amount of water in the functional ingredient composition can be in a range of 10 wt % to 98 wt %, or 15 wt % to 95 wt %, or 20 wt % to 85 wt %, or 25 wt % to 75 wt %, or 30 wt % to 70 wt %, or 10 wt % to 40 wt %, or 35 wt % to 60 wt %, based on the total weight of the functional ingredient composition.

### 1. Direct Formation of Dewatered Product in Flowable Powder Form

In some methods, the resulting dewatered product is in the form of a flowable powder. The flowable powder form of the product can be achieved by controlling the ratio of the solid base to the functional ingredient composition. In the methods provided herein, a dewatered product in the form of a flowable powder can be produced when the ratio of the solid base to the functional ingredient composition used in the method is in the range of about 5:1 to 15:1. The ratio of solid base to functional ingredient composition used in the method can be 5:1, 5.5:1, 6:1, 6.5:1, 7:1, 7.5:1, 8:1, 8.5:1, 9:1. 9.5:1, 10:1. 10.5:1, 11:1, 11.5:1, 12:1, 12.5:1, 13:1. 13.5:1, 14:1, 14.5:1, or 15:1.

When the ratio of solid base to functional ingredient composition used in the method is in the range of about 5:1 to 15:1, the ratio of solid base to polyester solvent used in the method can be in the range of about 3:1 to 8.5:1. The ratio of solid base to polyester solvent used in the method can be in the range of about 3.5:1 to 8:1. The ratio of solid base to polyester solvent used in the method can be 3:1, 3.25:1, 3.5:1, 3.75:1, 4:1, 4.25:1, 4.5:1, 4.75:1, 5:1, 5.25:1, 5.5:1, 5.75:1, 6:1, 6.25:1, 6.5:1, 6.75:1, 7:1. 7.25:1, 7.5:1, 7.75:1, 8:1, 8.25:1, or 8.5:1.

When the ratio of solid base to functional ingredient composition used in the method is in the range of about 5:1 to 15:1, the ratio of polyester solvent to functional ingredient composition used in the method can be in the range of about 1:1 to 3:1. The ratio of polyester solvent to functional ingredient composition used in the method can be in the range of about 1.1:1 to 2.75:1. The ratio of polyester solvent to functional ingredient composition used in the method can be 1:1, 1.1:1, 1.25:1, 1.5:1, 1.75:1, 2:1, 2.25:1, 2.5:1. 2.75:1, or 3:1.

Any mixing equipment known in the art that can mix and combine components can be used in the methods provided herein. Known devices, such as a KitchenAid® countertop stand mixer, a Hobart® planetary mixer, a vee-blender, a vee-cone blender, a rotary batch mixer, a ribbon blender, a paddle blender, a plow blender, a screw mixer, a turbulizer, a Nauta® mixer, a double arm kneader mixer, or combinations thereof, can be used to mix the components in the methods provided herein. The mixing can be carried out at room temperature under atmospheric pressure, and is not adversely affected by temperature or pressure conditions.

The mixing can be performed for 10 minutes or more. The amount of time required can depend on the amount of material to be mixed and the size and type of mixing equipment selected. In some methods, the mixing is performed from about 10 to 60 minutes.

After the reaction has concluded, the dewatered product in the mixer is in the form of a flowable powder. The dewatered product can be removed from the mixer, and packaged, or can be allowed to age for 1 to 24 hours before use, or can be used directly from the mixer for use as a component in a formulation for a granulated or tableted product.

### 2. Dewatered Product in the Form of a Viscous Fluid, Gel, or Putty

In the methods provided herein, when the ratio of the solid base to the functional ingredient composition used in the method is in the range of about 5:1 to 15:1, the resulting dewatered product is in the form of a viscous fluid. Upon aging without mixing for a period of about 3 to 8 hours, the dewatered product develops into a gel consistency. Upon further aging, from about 18 to 24 hours after the initial mixing, the dewatered product develops into a putty consistency.

The viscous fluid form of the product can be achieved by controlling the ratio of the solid base to the functional ingredient composition. In the methods provided herein, a dewatered product in the form of a viscous fluid can be produced when the ratio of the solid base to the functional ingredient composition used in the method is in the range of about 3:1 to 1:5. The ratio of solid base to functional ingredient composition used in the method can be 3:1, 2.5:1, 2:1, 1.5:1, 1:1, 1:1.5, 1:2, 1:2.5, 1:3, 1:3.5, 1:4, 1:4.5, or 1:5.

When the ratio of solid base to functional ingredient composition used in the method is in the range of about 3:1 to 1:5, the ratio of solid base to polyester solvent used in the method can be in the range of about 3.5:1 to 1:11. The ratio of solid base to polyester solvent used in the method can be 3:5, 3:1, 2.5:1, 2:1, 1.5:1, 1:1, 1:1.5, 1:2. 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, 1:10.5, or 1:11.

When the ratio of solid base to functional ingredient composition used in the method is in the range of about 3:1 to 1:5, the ratio of polyester solvent to functional ingredient composition used in the method can be in the range of about 4:1 to 1:4. The ratio of polyester solvent to functional ingredient composition used in the method can be in the range of about 3:1 to 1:3. The ratio of polyester solvent to functional ingredient composition used in the method can be 4:1, 3.5:1, 3:1, 2.5:1, 2:1, 1.5:1, 1.1, 1:1.5, 1:2, 1:2.5, 1:3, 1:3.5, or 1:4.

Any mixing equipment known in the art that can mix and combine components can be used in the methods provided herein. Known devices, such as a KitchenAid® countertop stand mixer, a Hobart® planetary mixer, a vee-blender, a vee-cone blender, a rotary batch mixer, a ribbon blender, a paddle blender, a plow blender, a screw mixer, a turbulizer, a Nauta® mixer, a double arm kneader mixer, or combinations thereof, can be used to mix the components in the methods provided herein. The mixing can be carried out at room temperature under atmospheric pressure, and is not adversely affected by temperature or pressure conditions.

The mixing can be performed for 10 minutes or more. The amount of time required can depend on the amount of material to be mixed and the size and type of mixing equipment selected. In some methods, the mixing is performed from about 10 to 60 minutes.

After the reaction has concluded, the dewatered product in the mixer is in the form of a viscous liquid. The viscous liquid can be allowed to age without mixing for a period of about 3 to 8 hours, resulting in a dewatered product having a gel consistency. Upon further aging, from about 18 to 24 hours after the initial mixing, the dewatered product develops into a putty consistency.

The dewatered product, whether in the form of a viscous liquid, a gel, or a putty, can be converted into a flowable powder by mixing with a flow aid. Any flow aid known in the art can be used. In some embodiments, the flow aid comprises a neutral salt, such a sodium chloride, potassium chloride sodium sulfate, or potassium sulfate, or combinations thereof. In some embodiments, the flow aid comprises a Na and/or K salt of at least one of an acetate, carbonate, bicarbonate, citrate, phosphate, silicate or aluminate, or combinations thereof. In some embodiments, the flow aid can comprise a low bulk density carbonate or bicarbonate or combination thereof. In some embodiments, the flow aid can comprise an expanded percarbonate as described in U.S. Pat. No. 8,652,434 (Moore et al., 2014). The amount of flow aid added can be in a ratio of from 1:1 to 5:1 flow aid to dewatered product. For example, 8 parts flow aid can be added to 2 parts dewatered product, or 6 parts flow aid can be added to 4 parts dewatered product.

The flow aid can be added to the dewatered product in the mixer directly after the initial mixing period, or the dewatered product can be allowed to age from 1 to 24 hours before adding the flow aid. The mixing can be performed for 10 minutes or more. The amount of time required can depend on the amount of material to be mixed, the size and type of mixing equipment selected, and the form of the dewatered product (viscous liquid, gel, or putty). In some methods, the mixing is performed from about 10 to 60 minutes. The mixing can continue until a flowable powder is produced.

The resulting flowable powder can be removed from the mixer, and packaged, or can be used directly from the mixer for use as a component in a formulation for a granulated or tableted product.

In some methods where the resulting dewatered product after aging has a hard putty consistency, the dewatered product can be converted into a flowable powder by application of energy alone to comminute the aged product into small particles without the need of adding a flow-aid. Any device known in the art for comminution can be used to product particles of the dewatered product. Examples include impact mills, FitzMill® comminutors, and coffee grinders.

In some embodiments, instead of using a flow aid, the components of a formulation can be added directly to the dewatered product in the mixer, with one or more of the components of the formulation essentially acting as flow aid material(s). Alternatively, components of a formulation can be mixed together in a mixer, and the dewatered product (as a viscous liquid, gel, or putty) can be added to the mixed components. Mixing of the components of a formulation with the dewatered product can be performed until a flowable powder is produced. The resulting flowable powder then can be processed to be a granulated product, or compressed into a tablet form.

### D. Resulting Dewatered Product

In some embodiments, the amount of detectable water in the dewatered product, whether produced directly as a flowable powder form or as a viscous liquid of gel, produced by the methods provided herein is no more than 33% of the starting amount of the water in the functional ingredient composition. For example, if the starting amount of the water in the functional ingredient composition was 50 wt %, then the amount of water in the dewatered product produced by the method would be no more than about 16.5 wt %.

In some embodiments, the amount of detectable water in the dewatered product produced by the methods provided herein is no more than 25% of the starting amount of the water in the functional ingredient composition. For example, if the starting amount of the water in the functional ingredient composition was 50 wt %, then the amount of water in the dewatered product produced by the method would be no more than about 12.5 wt %.

In some embodiments, the amount of detectable water in the dewatered product produced by the methods provided herein is no more than 15% of the starting amount of the water in the functional ingredient composition. For example, if the starting amount of the water in the functional ingredient composition was 50 wt %, then the amount of water in the dewatered product produced by the method would be no more than about 7.5 wt %.

In some embodiments, the amount of detectable water in the dewatered product produced by the methods provided herein is no more than 10% of the starting amount of the water in the functional ingredient composition. For example, if the starting amount of the water in the functional ingredient composition was 50 wt %, then the amount of water in the dewatered product produced by the method would no more than about 5 wt %.

In some embodiments, the amount of detectable water in the dewatered product can be no more than 20%, no more than 19%, no more than 18%, no more than 17%, no more than 16%, no more than 15%, no more than 14%, no more than 13%, no more than 12%, no more than 10%, no more than 9%, no more than 8%, no more than 7%, no more than 6%, no more than 5%, no more than 4%, no more than 3%, no more than 2%, no more than 1% of the starting amount of the water in the functional ingredient composition.

The methods provided herein “remove” at least a portion of the water present in the starting functional ingredient composition by converting at least a portion of the water into other more desirable products, such as glycerin, ethanol, or sodium acetate, and therefore there is minimal loss of total weight compared to the total weight of the solid base, polyester solvent, and functional ingredient composition added to the mixer at the start of the method. In the methods provided herein, a difference between a total weight of the solid base, the polyester solvent and the functional ingredient added to the mixer, and a final weight of the dewatered product produced by the method, is 2% or less. In some embodiments, the weight loss is 1.5 wt % or less, or 1 wt % or less, 0.75 wt % or less. In some embodiments, the weight loss is 0.6 wt % or less. In some embodiments, the weight loss is 0.5 wt % or less.

The dewatered product produced by the methods are substantially stable at room temperature for a year or more. When dissolved in a solvent, the dewatered product functional ingredient compositions provided herein exhibit the same or substantially similar activity or functionality as the equivalent amount of the functional ingredient in its original water-containing formulation.

### E. Use in Formulations

The dewatered product produced by the methods provided herein can be provided as a flowable powder, or can be converted into a flowable powder by mixing with a flow aid, or can be mixed directly into other components of a formulation to form a flowable powder. The dewatered product can be used as a component in a formulation, particularly formulations to be provided in the form or a flowable powder, agglomerate, or tablet.

The formulations containing the dewatered product produced by the methods herein can be converted into any desired form using techniques known in the art. For example, formulations containing the dewatered product produced by the methods provided herein can be provided as a powder, agglomerate, tablet, capsule, pellet, puck, brick, briquette, block, or composite. The formulations containing the dewatered product produced by the methods provided herein can be can be mixed with or dissolved in a solvent to provide a composition in the form of a liquid.

In some applications, formulations containing the dewatered product produced by the methods provided herein can be provided in the form of a tablet. In some embodiments, the tablet is a compressed tablet. Formulations to be made into a tablet form can include an amount of the dewatered product produced by the methods provided herein in a range of about 5 wt % to 95 wt % based on a total weight of the compressed tablet. In some embodiments, the compressed tablet can include an amount of the dewatered product in a range of about 10 wt % to 75 wt % based on a total weight of the compressed tablet.

The tablet compositions can include one or more additional components. Exemplary additional components include, e.g., an organic solvent, one or more additional surfactants, buffering salts, tablet lubricants, fragrances, colorants, chelants (e.g., iminodisuccinic acid salts (available as Baypure® CX 100 from Lanxess Deutschland GmbH, Leverkusen, Germany) and methylglycine-diacetic acid (Trilon® M from BASF, Florham Park, NJ), enzymes, acids, additional carbonates or bicarbonates, phosphates, wetting agents, dispersing agents, hydrotropes, an effervescent generator, rheology control agents, foam suppressants, and other functional additives.

In some applications, the formulation for a tablet composition can include an expanded percarbonate as described in U.S. Pat. No. 8,652,434 (Moore et al., 2014) as an additional component. In some applications, the formulation for a tablet composition can include an acid selected from among acetic, adipic, azelaic, citric, fumaric, glutaric, maleic, malonic, oxalic, pimelic, suberic, sebacic, succinic acid, and combinations thereof, as an additional component. In some applications, the formulation for a tablet composition can include a solid acetic acid, such as described in U.S. Pat. No. 8,859,482 (Moore et al., 2014). In some applications, the formulation for a tablet composition can include an enzyme selected from among a lipase, a protease, a peroxidase, an oxidase, an amylolytic enzyme, a cellulase, a polyesterase, a glucanase, an amylase, a glucoamylase, a glycosidase, a hemicellulase, a mannanase, a xylanase, a xyloglucanase, a pectinase, a β-glucosidase, or any combination thereof.

When present in the tablet composition with the dewatered product produced by the methods provided herein, an additional component can be present in an amount in the range of about 0.05% to 75%, or in the range of about 0.25% to 60%, or in the range of about 0.5% to 50%, or in the range of about 0.75% to 40% based on the total weight of the tablet.

Tablets have several advantages over powdered products: they do not require measuring and are thus easier to handle and dispense, and they are more compact, facilitating more economical storage and reducing shipping costs. A tablet containing the dewatered product produced by the methods provided herein can be of any geometric shape. Exemplary shapes include spherical, cube, disk, rod, triangular, square, rectangular, pentagonal, hexagonal, lozenge, modified ball, core rod type (with hole in center), capsule, oval, bullet, arrowhead, compound cup, arc triangle, arc square (pillow), diamond, half-moon and almond. The tablets can be convex or concave. The tablets can be flat-faced plain, flat-faced bevel-edged, flat-faced radius edged, concave bevel-edged or any combination thereof. In some embodiments, the tablet can have a generally axially-symmetric form and can have a round, square or rectangular cross-section

Tablets containing the dewatered product produced by the methods provided herein can be prepared using any method known in the art, including compression, casting, briquetting, injection molding and extrusion. In some embodiments, the tablet can be produced by compression, for example in a tablet press. Direct compression often is considered to be the simplest and the most economical process for producing tablets. Direct compression requires only two principal steps: the mixing of all the ingredients and compressing this mixture into a tablet. Any method known in the art for formation of a tablet can be used to prepare a tablet containing the dewatered product produced by the methods provided herein. For example, the components of the formulation including the dewatered product provided herein can be prepared by mixing the components together to achieve a uniform mix. Any powder blending, mixing or shaking technique that results in a uniform final product can be used. Known devices, such as a Hobart® planetary mixer, a vee-blender, a vee-cone blender, a rotary batch mixer, a fluidized bed mixer, a ribbon blender, a paddle blender and a plow blender or combinations thereof, can be used to mix the components. The uniform blend can be blended with lubricants or other excipients known in the art prior to tableting.

The resulting uniform mix then can be placed into a die of the desired geometry in a conventional tablet press, such as a single stroke or rotary press. The press includes a punch suitably shaped for forming the tablet. The uniform mix is then subjected to a compression force sufficient to produce a tablet, and a tablet containing the dewatered product produced by the methods provided herein is ejected from the tablet press. Agglomerates and granules also can be used to form tablets. The agglomerates or granules can be blended with lubricants or other excipients prior to tableting.

Any tableting equipment known in the art can be used for tablet formation. Suitable equipment includes a standard single stroke or a rotary press. Such presses are commercially available, and are available from, e.g., Carver, Inc. (Wabash, IN), Compression Components & Service, LLC (Warrington, PA), Specialty Measurements Inc. (Lebanon, NJ), GEA Pharma Systems (Wommelgem, Belgium), Korsch America Inc. (South Easton, MA) or Bosch Packaging Technology (Minneapolis, MN). The tableting can be carried out at room temperature under atmospheric pressure, and is not adversely affected by temperature or pressure conditions.

The dewatered product produced by the methods provided herein can be included in a unit dosage form. The unit dosage form can be dissolved in a solvent to produce a functional solution. The functional solution can be, e.g., a solution for cleaning or sanitizing a surface. In addition to the dewatered product produced by the methods provided herein, the unit dosage form can include one or more than one additional component. The additional component can be selected from among an organic solvent, an additional surfactant, a buffering salt, a lubricant, a fragrance, a colorant, a chelant, an enzyme, an acid, a carbonate, a bicarbonate, a phosphate, a wetting agent, a dispersing agent, a hydrotrope, an effervescent generator, a rheology control agent, a foam suppressant, and a combination thereof.

### F. Packaged Systems

The dewatered product produced by the methods provided herein can be packaged with a packaging material to form a packaged system. The compressed tablets or unit dosage forms containing the dewatered product produced by the methods provided herein can be packaged with a packaging material to form a packaged system. The packaging material can be rigid or flexible, and can be composed of any material suitable for containing the flowable powder produced by the methods provided herein. Examples of suitable packaging materials include glass, metal foil, treated metal foil, metal foil pouches, plastic, plastic film, plastic sheets, blister packs, cardboard, cardboard composites, paper and treated paper, and any combination thereof.

### G. Articles of Manufacture

The dewatered product produced by the methods provided herein can be part of an article of manufacture, which can include a container suitable for containing the compositions, such as for shipping and/or storage. The dewatered product produced by the methods provided herein can be stored or shipped in a variety of containers, and the containers can be made of or contain any of a variety of container materials, such as glass, acrylonitrile butadiene styrene (ABS), high impact polystyrene, polycarbonate, high density polyethylene, low density polyethylene, high density polypropylene, low density polypropylene, polyethylene terephthalate, polyethylene terephthalate glycol and polyvinylchloride and combinations thereof. The containers can include barrier films to increase storage stability. Suitable barrier films can include nylons, polyethylene terephthalate, fluorinated polyethylenes, and copolymers of acrylonitrile and methylmethacrylate.

An article of manufacture can include the dewatered product produced by the methods provided herein and a set of instructions, such as for the use of the dewatered product produced by the methods provided herein, or storage instructions, or a material safety data sheet, or any combination thereof.

### H. Applications

The dewatered product produced by the methods provided herein can be provided, alone or in combinations with additional components, in a unit dosage form, such as compressed tablets, capsules, pellets, pucks, bricks, briquettes, blocks or as dissolvable pouches or packets, that can be used to produce a desired formulation. Exemplary formulations include a sanitizing solution, a disinfecting solution, a surface cleaner, a hand wash product, a body wash product, a hair wash product, a hair conditioning product, a skin softening product, a dish soap or detergent product, a laundry detergent, a laundry softening product, a laundry anti-static product, and a pet odor removal product.

For example, the dewatered product produced by the methods provided herein can be incorporated with additional components into a unit dosage form for a formulation for cleaning or sanitizing a surface. Exemplary surfaces include, but are not limited to, bathroom surfaces (e.g., floor, drains, tub, shower, mirrors, sinks, toilet, toilet seat, urinal, bidet, lavatory pans, countertops, shower doors or curtains, shower stalls, wash basins, bathroom fixtures, windows, fans, walls, light fixtures and tiles); appliance surfaces (e.g., coffee maker, stove, oven, range, sink, garbage disposal, dishwashers, refrigerator, freezer, microwave, toaster, mixers, washing machine, dryer, barbeque); kitchen surfaces (e.g., appliances, floor, fixtures, light fixtures, fans, countertops, crockery, cupboards, cutlery, doors, door handles, walls, tables, chairs, cabinets, drawers, food processing equipment, flatware, utensils, floors, glassware, phones, clocks, plate ware, shelves, pantry, sinks, dishwashers, windows, and work surfaces); transportation devices (e.g., cars, bicycles, snowmobiles, motorcycles, off-road-vehicles, tractors, recreation vehicles, boats, and planes); yard equipment; farm equipment; laboratory surfaces (e.g., autoclaves, work surfaces, hoods, clean rooms, storage rooms, cold rooms, countertops, centrifuges, and floors); computer surfaces (keyboards, monitors, housing, towers, laptops, and cables); hand rails; banisters; dental equipment or devices; medical devices or equipment; patient care equipment; patient monitoring equipment; surgical devices or equipment or instruments; veterinarian equipment; tools; and utility devices (e.g., telephones, radios, televisions, entertainment centers, stereo equipment, CD and DVD players, play stations, and analog and digital sound devices). Countertops can include tile surfaces, granite, marble or other stone surfaces, Corian® or other manmade hard surfaces, engineered quartz such as Viatera® quartz surfaces (LG Hausys), wood surfaces, glass surfaces, acrylic or polyester resin surfaces, concrete surfaces and stainless steel surfaces.

### I. Examples

The following examples are included for illustrative purposes only and are not intended to limit the scope of the embodiments provided herein.

### Examples 1-12

### Small Scale Preparation of Dewatered Product as Flowable Powder

500 gram batches were prepared in a KitchenAid® Ultra Power Stand Mixer (300 watt stand mixer-Whirlpool Corporation, Benton Harbor, MI) using the flat-beater attachment. The identities and amounts of the components used as starting materials are provided in Table 1.

TABLE 1
Exemplary Small Scale Production Formulations

| | Solid base | Polyester solvent | Aqueous Functional |
|---|---|---|---|
| Example | (wt %) | (wt %) | Ingredient (wt %) |
| 1 | Soda ash¹ - 72% | Triacetin⁵ - 19% | Crodasinic ^{™} LS30⁷ - 9% |
| 2 | Soda ash¹ - 72% | Triacetin⁵ - 18% | AlphaStep ® PC48⁸ - 10% |
| 3 | Soda ash¹ - 72% | Triacetin⁵ - 19% | ColaTeric ® BOB⁹ - 9% |
| 4 | Soda ash¹ - 70% | Triacetin⁵ - 20% | Crodasinic ® CS30¹⁰ - 9% |
| 5 | Soda ash¹ - 80% | Triacetin⁵ - 10% | Glucopon ® 420UP¹¹ - 6% |
| 6 | Soda ash¹ - 70% | Citrofol ® AI⁶ - 19% | AlphaStep ® PC48⁸ - 11% |
| 7 | MGDA² - 72% | Citrofol ® AI⁶ - 15% | Amphi ™ M¹² - 13% |
| 8 | MGDA² - 80% | Triacetin⁵ - 10% | Amphi ™ M¹² - 10% |
| 9 | GLDA³ - 80% | Triacetin⁵ - 10% | Amphi ™ M¹² - 10% |
| 10 | Baypure CX100⁴ - 80% | Triacetin⁵ - 10% | Amphi ™ M¹² - 10% |
| 11 | Soda ash¹ - 72% | Triacetin⁵ - 20% | MultiTrope ™ 810¹³ - 8% |
| 12 | Soda ash¹ - 72% | Triacetin⁵ - 19% | Zinador ™ 22L¹⁴ - 9% |

¹Soda ash—sodium carbonate (FMC Corporation, Philadelphia, PA, USA)
²MGDA—methylglycine N,N-diacetic acid trisodium salt (Nouryon Chemicals, Amsterdam, The Netherlands)
³GLDA—tetrasodium glutamate diacetate (Nouryon Chemicals, Amsterdam, The Netherlands)
⁴Baypure CX100—tetrasodium iminodisuccinate (RheinChemie Additives, Koln, Germany)
⁵Triacetin—glyceryl triacetate (Jiangsu Ruijia, Jiangsu Province, China)
⁶Citrofol ® AI—triethyl citrate (Jungbunzlauer, Basel, Switzerland)
⁷Crodasinic ™ LS30—sodium lauroyl sarcosinate (Croda Personal Care, New Castle, DE, USA)
⁸AlphaStep ® PC48—sodium methyl 2-sulfolaurate, disodium 2-fulfolaurate and water (Stepan Company, Northbrook, IL, USA)
⁹ColaTeric ® BOB—babassuamidopropyl betaine (Colonial Chemical, South Pittsburg, TN, USA)
¹⁰Crodasinic ® CS30—sodium cocoyl sarcosinate (Croda Personal Care, New Castle, DE, USA)
¹¹Glucopon ® 420UP—C8-C16 alkyl polyglucosides (caprylyl/myristyl glucoside) and water (BASF Care Creations, San Bruno, CA, USA)
¹²Amphi ™ M—lactonic sophorolipid CAS No.1573124-58-9 and water (Locus Performance Ingredients, Richmond, VA, USA)
¹³MultiTrope ™ 810—anionic surfactant and water (Croda Inc., Chino Hills, CA, USA)
¹⁴Zinador ™ 22L—polymeric zinc itaconate complex odor neutralizer and water (Croda Inc., Chino Hills, CA, USA)

The stainless-steel bowl of the mixer was first loaded with the solid base. Next the polyester solvent was added, and then the aqueous functional ingredient composition was added. The stand mixer then was activated to stir the components together using the lowest rpm setting. The initial mixing was performed for about 1-5 minutes and stopped so that an initial test sample can be taken from the mixture. The mixing operation then was restarted at the same lowest rpm setting and allowed to continue for additional time of about 30 minutes. The dewatered product was in the form of a flowable powder. Once the mixing operation was completed, the final flowable powder was transferred to a holding vessel and closed with a lid. Final test samples were taken at 1 hour and 24 hours after completion of the mixing. The test samples were analyzed on a Near Infra-Red spectrometer (NIRS XDS Rapid Content Analyzer-Model Xm-1100 Series-Metrohm, Riverview, FL) for analysis of changing in the amount of detectable water.

### Examples 13-24

### Tablet Formulations

A compressed tablet was formed incorporating the dewatered product flowable powder produced in Examples 1-12. The tablet formulations are provided in Table 2. For Examples 13-24, the components of the tablet formulation were blended together in a lab scale vee-blender for 5 minutes to achieve a homogeneous blend. Aliquots of the homogeneous blend in amounts from about 9 g to 20 were weighed to be made into compressed tablets using dies, such as dies having a diameter of about 27 to 38.1 mm. Each aliquot of the homogeneous blend separately was compressed into a tablet using a 38.1 mm diameter die using a CARVER Press at a pressure of about 4 to 8 metric tons.

TABLE 2
Exemplary Tablet Compositions

| | | Flowable | Additional | |
|---|---|---|---|---|
| | | Powder Usage | Components | |
| | Flowable | (wt % of total | (wt % of total | Product |
| Example | Powder | tablet weight) | tablet weight) | Type¹⁵ |
| 13 | Example 1 | 28 wt % | citric acid¹⁶ 45%; | hand and |
| | | | sodium bicarbonate¹⁷ | body wash |
| | | | 8%; Glycerox HE¹⁸ 3%; | product |
| | | | glucono-delta-lactone¹⁹ | |
| | | | 8%; sodium benzoate²⁰ | |
| | | | 8% | |
| 14 | Example 2 | 28 wt % | citric acid¹⁶ 38%; | high foaming |
| | | | sodium bicarbonate¹⁷ | dish soap |
| | | | 9%; sodium lauryl | |
| | | | sulfate²¹ 9%; glucono- | |
| | | | delta-lactone¹⁹ 8%; | |
| | | | sodium benzoate²⁰ 8% | |
| 15 | Example 3 | 28 wt % | citric acid¹⁶ 51%; | hand and |
| | | | sodium lauryl sulfate²¹ | body wash |
| | | | 7%; dextrose²² 8%; | product |
| | | | sodium benzoate²⁰ 3%; | |
| | | | potassium sorbate²³ 3% | |
| 16 | Example 4 | 50 wt % | citric acid¹⁶ 37.5%; | sulfate-free |
| | | | Glycerox HE¹⁸ 3%; | hand soap |
| | | | glucono-delta-lactone¹⁹ | |
| | | | 4%; sodium benzoate²⁰ | |
| | | | 5.5% | |
| 17 | Example 5 | 40 wt % | citric acid¹⁶ 46%; | hard surface |
| | | | glucono-delta-lactone¹⁹ | cleaner |
| | | | 7%; sodium benzoate²⁰ | |
| | | | 7% | |
| 18 | Example 6 | 32 wt % | citric acid¹⁶ 49%; | hard surface |
| | | | sodium lauryl sulfate²¹ | cleaner |
| | | | 5%; glucono-delta- | |
| | | | lactone¹⁹ 7%; sodium | |
| | | | benzoate²⁰ 7% | |
| 19 | Example 7 | 44 wt % | citric acid¹⁶ 36%; | a surface |
| | | | fumaric acid²⁴ 5%; | sanitizer |
| | | | sodium bicarbonate¹⁷ | |
| | | | 15% | |
| 20 | Example 8 | 50 wt % | citric acid¹⁶ 30%; | a general |
| | | | fumaric acid²⁴ 5%; | surface |
| | | | sodium bicarbonate¹⁷ | cleaner |
| | | | 15% | |
| 21 | Example 9 | 50 wt % | citric acid¹⁶ 30%; | a general |
| | | | fumaric acid²⁴ 5%; | surface |
| | | | sodium bicarbonate¹⁷ | cleaner |
| | | | 15% | |
| 22 | Example 10 | 50 wt % | citric acid¹⁶ 30%; | general |
| | | | fumaric acid²⁴ 5%; | surface |
| | | | sodium bicarbonate¹⁷ | cleaner |
| | | | 15% | |
| 23 | Example 11 | 12 wt % | sodium bicarbonate¹⁷ | laundry |
| | | | 17%; expanded Na | detergent |
| | | | percarbonate²⁵ 3%; C9-11 | |
| | | | ethoxylated alcohol | |
| | | | E.O.6²⁶ 3%; citric acid¹⁶ | |
| | | | 33%; fumaric acid²⁴ | |
| | | | 7%; sodium acetate²⁷ | |
| | | | 3.5%; glucono-delta- | |
| | | | lactone¹⁹ 12%; | |
| | | | polyacrylic acid²⁸ 3%; | |
| | | | enzyme blend²⁹ 6.5% | |
| 24 | Example 12 | 30 wt % | sodium bicarbonate¹⁷ | pet odor |
| | | | 7%; expanded sodium | removal |
| | | | percarbonate²⁵ 4%; 1,3- | product |
| | | | propanediol³⁰ 4.5%; | |
| | | | citric acid¹⁶ 45%; | |
| | | | sodium gluconate³¹ 5%; | |
| | | | sodium benzoate²⁰ | |
| | | | 2.5%; potassium | |
| | | | sorbate²³ 2%; | |

¹⁵When the tablet is dissolved in an appropriate solvent, such as water
¹⁶Citric acid (S.A. Citrique Belge N.V., Tienen, Belgium)
¹⁷Sodium bicarbonate (Solvay USA Inc., Albright, WV, USA)
¹⁸Glycerox ™ HE (Croda Personal Care, East Yorkshire, UK)
¹⁹Glucono-delta-lactone (Jungbunzlauer Suisse AG, Basel, Switzerland)
²⁰Sodium benzoate (Emerald Kalama Chemical, Kalama, WA, USA)
²¹Sodium lauryl sulfate (Stepan Company, Northfield, IL, USA)
²²Dextrose (Clintose ® dextrose A, ADM, Chicago, IL, USA)
²³Potassium sorbate (APAC Chem Corp., Nantong, China)
²⁴Fumaric acid (Bartek Ingredients, Inc., Ontario, Canada)
²⁵Expanded sodium percarbonate (see U.S. Pat. No. 8,652,434)
²⁶C9-11 Ethoxylated alcohol E.O.6 (Tomadol 91-6, Air Products, Allentown, PA, USA)
²⁷Sodium acetate (Niacet Corporation, Niagara Falls, NY, USA)
²⁸Polyacrylic acid (Sokalan PA25CL BASF, Florham Park, NJ, USA)
²⁹Enzyme blend (BioCat, Troy, VA, USA)
³⁰1,3-propanediol (ZEMEA ® propanediol, DuPont Tate & Lyle Bio Products, LLC, Loudon, TN, USA)
³¹Sodium gluconate (PMP Fermentation Products, Inc., Peoria, IL, USA)

### Example 25

### Large Scale Preparation of Flowable Powder

1041.67 pound batches were prepared in a 36 cu. ft. Ross ribbon blender (Model 42B-36-Charles Ross & Son Company, Hauppauge, NY).

The blender was first loaded with the solid base. Next the polyester solvent was added with the aqueous functional ingredient. The blender was then set to operate at 30 Hz. The initial mixing operation was run for about 1-5 minutes and stopped so initial test samples could be taken from the powder. The mixing operation then was allowed to continue for an additional 60 minutes. Once the mixing operation was completed the final flowable powder was transferred to a bulk powder bag and tied off. Final test samples were taken at 1 hour and 24 hours after completion of the mixing. The test samples were analyzed on a Near Infra-Red spectrometer (NIRS XDS Rapid Content Analyzer-Model Xm-1100 Series-Metrohm, Riverview, FL) for analysis of changing water peaks.

### Examples 26-29

### Evaluation of Water Loss

Small scale production runs were performed to analyze weight loss that occurs during the process. 500 g batches were prepared in a KitchenAid® Ultra Power Stand Mixer (300 watt stand mixer-Whirlpool Corporation, Benton Harbor, MI) using the flat-beater attachment as described above for Examples 1-12. The identities and amounts of the components used as starting materials are provided in Table 3. The weight loss data also is provided in Table 3.

TABLE 3
Weight Loss

| | | | Aqueous | Initial | Batch | Batch | Total % |
|---|---|---|---|---|---|---|---|
| | Solid | Polyester | Functional | Batch | wt. @ | wt. @ | wt. loss |
| Example | Base | Solvent | Ingredient | wt. | 1 hr | 24 hr | @ 24 hr |
| 26 | Soda ash¹ | Triacetin⁵ | Crodateric ® | 500 g | 497.4 g | 497.1 g | 0.58% |
| | 71.5% | 18.5% | CAB30³² - | | | | |
| | | | 10% | | | | |
| 27 | Soda ash¹ | Triacetin⁵ | Crodasinic ® | 500 g | 498.9 g | 498.7 g | 0.26% |
| | 72% | 19% | LS30⁷ - 9% | | | | |
| 28 | Soda ash¹ | Citrofol AI⁶ | Crodasinic ® | 500 g | 497.3 g | 497.0 g | 0.60% |
| | 72% | 19% | LS30⁷ - 9% | | | | |
| 29 | Soda ash¹ | Triacetin⁵ | Plantaren ® | 500 g | 499.1 g | 498.4 g | 0.32% |
| | 72% | 15% | 818UP³³ - | | | | |
| | | | 13% | | | | |

¹Soda ash—sodium carbonate (FMC Corporation, Philadelphia, PA, USA)
⁵Triacetin—glyceryl triacetate (Jiangsu Ruijia, Jiangsu Province, China)
⁶Citrofol ® AI—triethyl citrate (Jungbunzlauer, Basel, Switzerland)
⁷Crodasinic ® LS30—sodium lauroyl sarcosinate (Croda Personal Care, New Castle, DE, USA)
³²Crodateric ® CAB30—cocamidopropyl betaine (Croda Personal Care, New Castle, DE, USA)
³³Plantaren ® 818UP—coco-glucoside (BASF Care Creations, Florham Park, NJ, USA)

As can be seen from the data in Table 3, weight loss after 24 hours from the completion of mixing was less than 1%, in a range from 0.26% to 0.60%.

### Examples 30-45

### Small Scale Preparation of Dewatered Product as Viscous Fluid/Gel

200 gram batches were prepared in a KitchenAid® Ultra Power Stand Mixer (300 watt stand mixer-Whirlpool Corporation, Benton Harbor, MI) using the flat-beater attachment and mixed for 30 minutes. The identities and amounts of the components used as starting materials are provided in Table 4.

TABLE 4
Exemplary Small Scale Production Formulations

| | | | Aqueous |
|---|---|---|---|
| | Solid | Polyester | Functional |
| | base¹ | solvent⁵ | Ingredient⁷ |
| Example | (wt %) | (wt %) | (wt %) |
| 30 | 30 | 42 | 28 |
| 31 | 30 | 40 | 30 |
| 32 | 50 | 40 | 10 |
| 33 | 30 | 42 | 28 |
| 34 | 30 | 28 | 42 |
| 35 | 50 | 25 | 25 |
| 36 | 40 | 12 | 48 |
| 37 | 15 | 25 | 60 |
| 38 | 35 | 37.14 | 27.86 |
| 39 | 25 | 42.86 | 32.14 |
| 40 | 20 | 45.71 | 34.29 |
| 41 | 15 | 48.57 | 36.43 |
| 42 | 10 | 51.43 | 38.57 |
| 43 | 40 | 34.28 | 25.72 |
| 44 | 45 | 31.42 | 23.58 |
| 45 | 50 | 28.56 | 21.44 |

¹Soda ash—sodium carbonate (FMC Corporation, Philadelphia, PA, USA)
⁵Triacetin—glyceryl triacetate (Jiangsu Ruijia, Jiangsu Province, China)
⁷Crodasinic ® LS30—sodium lauroyl sarcosinate (Croda Personal Care, New Castle, DE, USA)

After 30 minutes of mixing, the resulting product was a viscous liquid. Certain dewatered products were allowed to age. After aging for 3 hours without mixing, the aged dewatered product had a gel consistency. After 24 hours of aging without mixing, the aged dewatered product had a putty-like consistency. The results for exemplary aged dewatered products are listed in Table 5.

TABLE 5
Exemplary Aged Small Scale Production Formulations

| | | | Aqueous | |
|---|---|---|---|---|
| | Solid | Polyester | Functional | Aged Dewatered |
| | base¹ | solvent⁵ | Ingredient⁷ | Product |
| Example | (wt %) | (wt %) | (wt %) | Description |
| 30 | 30 | 42 | 28 | Very soft putty |
| 35 | 50 | 25 | 25 | Hard putty |
| 36 | 40 | 12 | 48 | Normal putty |
| 39 | 25 | 42.86 | 32.14 | Soft putty |
| 42 | 10 | 51.43 | 38.57 | Very soft putty |

After 24 hours of aging without mixing, Examples 30 and 42 had the consistency of a very soft putty that was easily deformable, and having a consistency similar to bread dough. After 24 hours of aging without mixing, Example 39 had the consistency of a soft putty requiring minimal force to deform, similar to a soft pomade or balm. After 24 hours of aging without mixing, Example 36 had a consistency of a normal putty similar to that of Silly Putty or Play-Doh being deformable with moderate force. After 24 hours of aging without mixing, Example 35 had a consistency of a hard putty, like a carnauba paste car wax, that required the application of a moderately high force in order to deform.

### Examples 46-48

Conversion of Aged Dewatered Product into Flowable Powder

The formulation of Example 42 (10% soda ash, 51.43% Triacetin, 38.57% Crodasinic® LS30) was used to prepare a dewatered product. Three 200 gram batches were prepared by mixing the components in a KitchenAid® Ultra Power Stand Mixer (300 watt stand mixer-Whirlpool Corporation, Benton Harbor, MI) using the flat-beater attachment for 30 minutes. The dewatered product was allowed to age without mixing for a 24 hour period before converting into a flowable powder. The aged product had the consistency of bread dough and was easily deformable.

An aliquot from each preparation was converted into a flowable powder. The amount of the dewatered product and the flow aid identity and amount are provided in Table 6.

TABLE 6
Conversion of Viscous Fluid/Gel Dewatered
Product into Flowable Powder

| Example | Example 42 (wt %) | Flow aid | Flow aid amount (wt %) |
|---|---|---|---|
| 46 | 20 | Sodium | 80 |
| | | chloride³⁴ | |
| 47 | 33.33 | Sodium | 66.67 |
| | | chloride³⁴ | |
| 48 | 20 | Sodium | 80 |
| | | sulfate³⁵ | |

³⁴Sodium chloride (Morton Salt, Inc., Chicago, IL, USA)
³⁵Sodium sulfate (Saltex, LLC, Fort Worth, TX, USA)

The aliquot of the dewatered product of Example 42 was placed in the bowl of a KitchenAid® Ultra Power Stand Mixer (300 watt stand mixer-Whirlpool Corporation, Benton Harbor, MI), the flow aid was added, and the mixture was mixed using the flat-beater attachment for 30 minutes. The resulting product for each was a flowable powder.

### Examples 49-51

### Tablet Compositions

The flowable powder form of the dewatered product provided in Examples 46 to 48 was used to prepare a tablet form of a formula for a neutral surface cleaner. The components and amounts are provided in Table 7.

TABLE 7
Exemplary Neutral Surface Cleaner Formulations

| Ingredient | Example 49 | Example 50 | Example 51 |
|---|---|---|---|
| Powder - Example 46 | 10 | — | — |
| Powder - Example 47 | — | 20 | — |
| Powder - Example 48 | — | — | 10 |
| Citric acid¹⁶ | 38 | 35 | 40 |
| Sodium bicarbonate¹⁷ | 40 | 32 | 40 |
| Sodium acetate²⁷ | 7 | 8 | 5 |
| PEG 8000³⁶ | 5 | 5 | 5 |

¹⁶Citric acid (S.A. Citrique Belge N.V., Tienen, Belgium)
¹⁷Sodium bicarbonate (Solvay USA Inc., Albright, WV, USA)
²⁷Sodium acetate (Niacet Corporation, Niagara Falls, NY, USA)
³⁶Pluriol ® E8000 (BASF Personal Care, San Bruno, CA, USA)

For Examples 49 to 51, the components of the tablet formulation were blended together in a lab scale vee-blender for 5 minutes to achieve a homogeneous blend. Aliquots of the homogeneous blend in amounts from about 8 to 10 grams were weighed to be made into compressed tablets using a 1 inch (2.54 cm) die. Each aliquot of the homogeneous blend separately was compressed into a tablet using a CARVER Press at a pressure of about 4 to 8 metric tons.

### Examples 52-56

Experiments were conducted to demonstrate water reduction over time using the methods described herein. The water peaks at 1400 nm and 1900 nm were monitored over time using NIR. Using glass tumblers from Metrohm ((part #6.7400.010, Metrohm AG, Riverview, FL)) 12 g batches of 5 different mixes were made directly in the tumbler in order to obtain the initial water peak readings as close to time zero as possible. The formulations for the mixes are shown in Table 8.

TABLE 8
Formulations for Water Reduction Measurements

| | Mix | Mix | Mix | Mix | Mix |
|---|---|---|---|---|---|
| | 1 | 2 | 3 | 4 | 5 |
| Soda Ash¹ | 75 | 72 | 75 | 75 | — |
| Trilon ® M² | — | — | — | — | 90 |
| Triacetin⁵ | 17 | 19 | 17 | 17 | 6.8 |
| Surfactant: | | | | | |
| ColaTeric ® BOB⁹ | — | — | — | 8 | 3.2 |
| Crodasinic ® LS30⁷ | — | 9 | — | — | — |
| Plantapon ® LGC Sorb³⁸ | 8 | — | — | — | — |
| Hostapon CGN³⁹ | — | — | 8 | — | — |

¹Soda ash—sodium carbonate (FMC Corporation, Philadelphia, PA, USA)
³⁷Trilon ® M—trisodium salt of methylglycinediacetic acid (MDGA-Na₃) from BASF, Florham Park, NJ
⁵Triacetin—glyceryl triacetate (Jiangsu Ruijia, Jiangsu Province, China)
⁹ColaTeric ® BOB—babassuamidopropyl betaine (Colonial Chemical, South Pittsburg, TN, USA)
⁷Crodasinic ™ LS30—sodium lauroyl sarcosinate (Croda Personal Care, New Castle, DE, USA)
³⁸Plantapon ® LGC Sorb—sodium lauryl glucose carboxylate (and) lauryl glucoside, (BASF, Florham Park, NJ)
³⁹Hostapon ® CGN—sodium cocoyl glutamate (Clariant Produkte (Deutschland) GmbH, Frankfurt am Main, GERMANY)

### Procedure

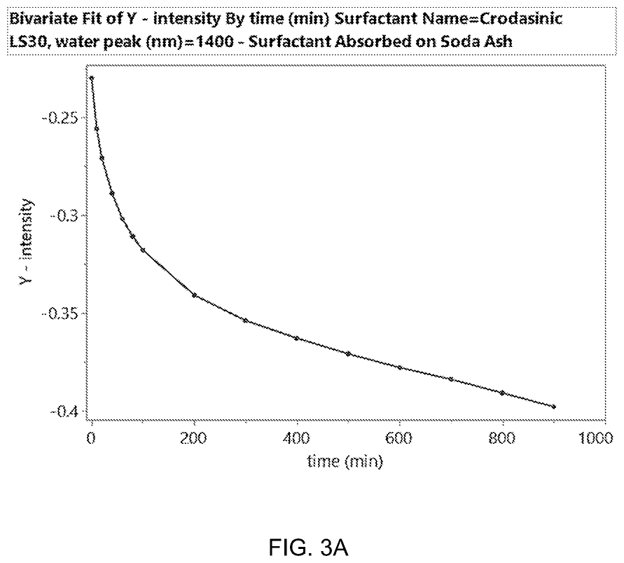

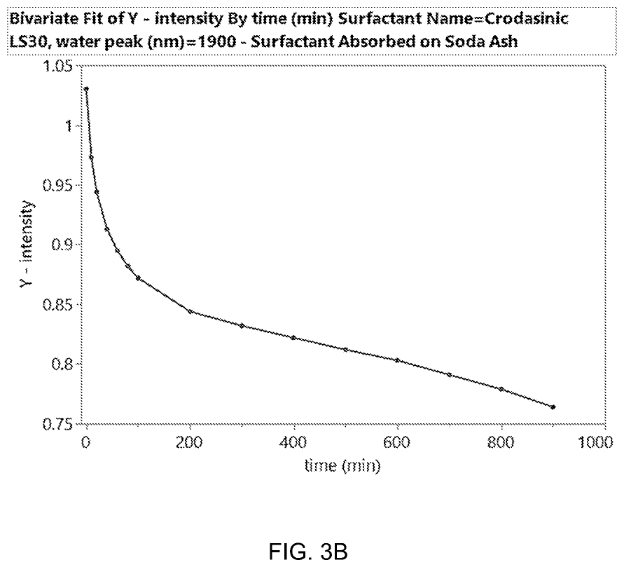

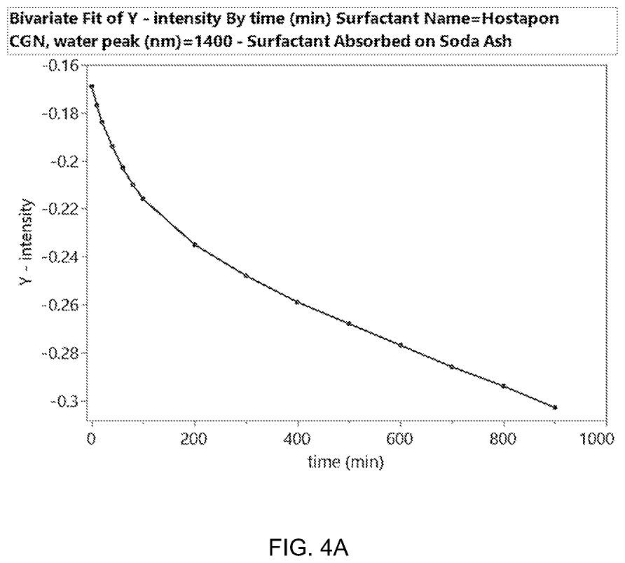

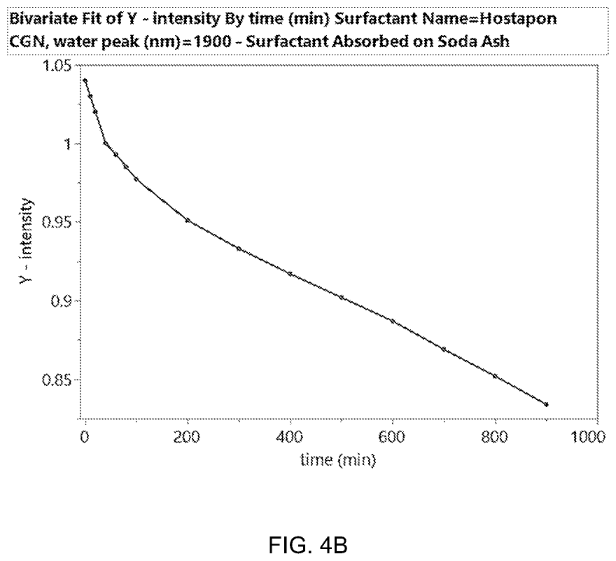

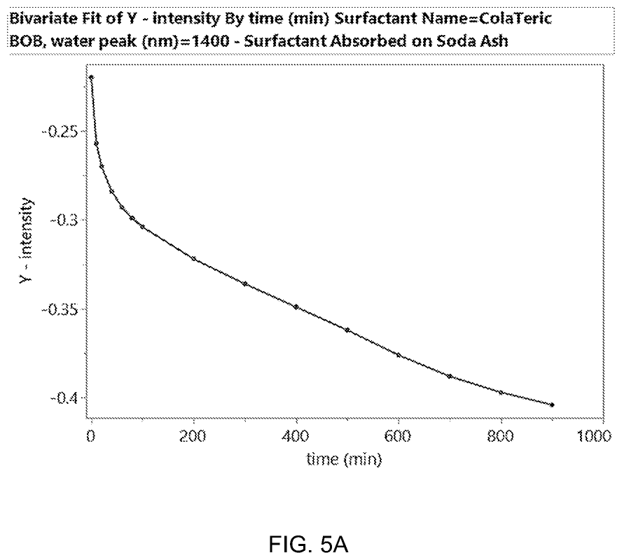

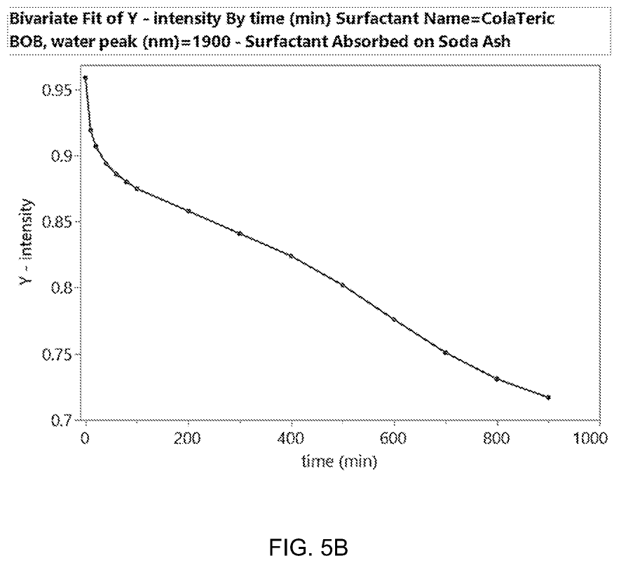

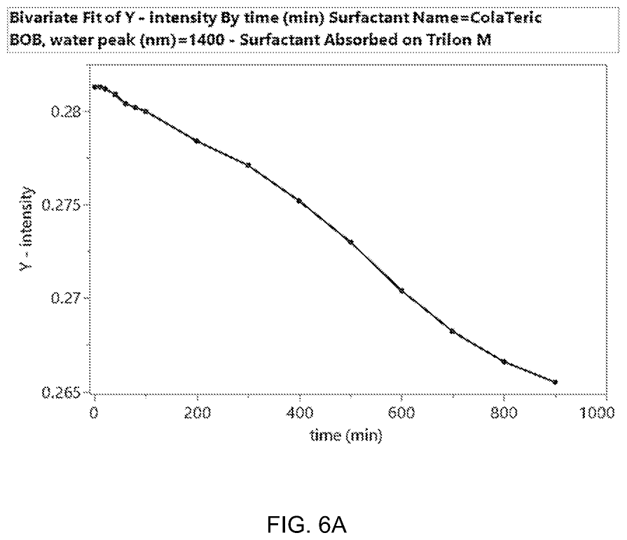

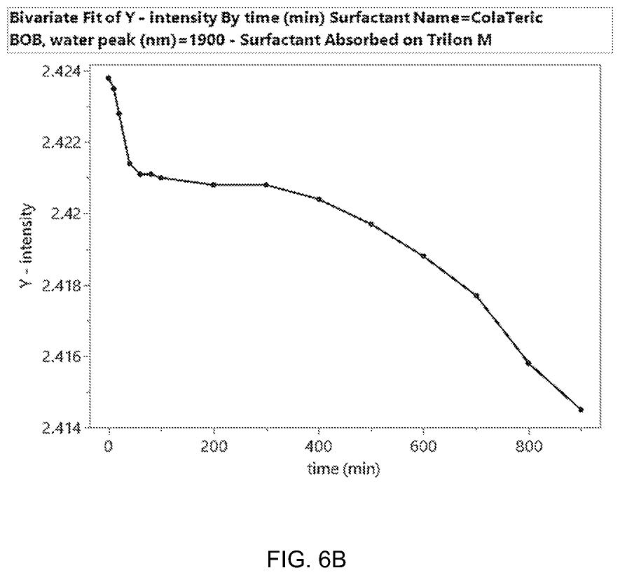

The soda ash or Trilon® M and the surfactant were dispensed into the tumbler, then the triacetin was added, the contents mixed for about 30 seconds with a glass rod and a measurement with a Near Infra-Red spectrometer (NIRS XDS Rapid Content Analyzer-Model Xm-1100 Series-Metrohm, Riverview, FL) was immediately taken. The focus of the measurements was on the two water band peaks found at 1400 nm and 1900 nm. Each sample was covered and left on the NIR overnight. The NIR automatically took readings at regular intervals for a time period of up to 900 minutes (15 hours). The results are shown in FIGS. 2A to 6B. Each chart in the figures shows the reduction of intensity (‘Y’) of the water peaks (1400 nm and 1900 nm) separately, which correlates to the reduction of the amount of water molecules in the blends. The x-axis shows the time of measurement. FIGS. 2A and 2B shows the results obtained for Mix 1. FIGS. 3A and 3B shows the results obtained for Mix 2. FIGS. 4A and 4B shows the results obtained for Mix 3. FIGS. 5A and 5B shows the results obtained for Mix 4. FIGS. 6A and 6B shows the results obtained for Mix 5. As can be seen in all of the figures, the methods provided herein result in significant reduction of water over time. None of the samples had more than 0.2 g weight loss from the overnight NIR readings.

### Example 57

A formulation incorporating the dewatered product of Mix 1 described above was prepared. After 900 minutes of reaction time, Mix 1 (75 wt % soda ash, 17 wt % triacetin, and 8 wt % Plantapon® LGC) was used to prepare a foaming hand soap formulation.

TABLE 9
Foaming Hand Soap Formulation

| Component | Amount (wt %) |
|---|---|
| Dewatered Mix 1 | 18 |
| Citric Acid¹⁶ | 35 |
| Sodium bicarbonate¹⁷ | 12.5 |
| Fragrance | 2 |
| GDL (Glucono-delta-lactone)¹⁹ | 13.5 |
| Sodium benzoate²⁰ | 9.5 |
| SLS (sodium lauryl sulfate)²¹ | 9.5 |

¹⁶Citric acid (S.A. Citrique Belge N.V., Tienen, Belgium)
¹⁷Sodium bicarbonate (Solvay USA Inc., Albright, WV, USA)
¹⁹Glucono-delta-lactone (Jungbunzlauer Suisse AG, Basel, Switzerland)
²⁰Sodium benzoate (Emerald Kalama Chemical, Kalama, WA, USA)
²¹Sodium lauryl sulfate (Stepan Company, Northfield, IL, USA)

The components shown in Table 9 were blended together to make a final blend having a weight of 200 g. Then, a 15 gram aliquot was removed from the blend and pressed into a tablet with a die size of 1.25″ in diameter on a CARVER PRESS at roughly 8 metric tons. One tablet was added to 240 mL of water (for a total of 255 mL) to form the foaming hand soap formulation. When the final solution was used in a foaming pump, the foam was thicker and had good slip (silky feeling) compared to a formulation that does not contain the dewatered surfactant mix in combination with SLS. An even better skin feel and thicker foam enhancement was achieved when the dewatered surfactant mix of Mix 1 was used with a sulfate-free powdered surfactant, such as Lathanol LAL® or Amisoft CS-11 shown in Table 9.1.

TABLE 9.1
Foaming Hand Soap Formulations (Sulfate-Free)

| Component | Amount (wt %) | Amount (wt %) |
|---|---|---|
| Dewatered Mix 1 | 18 | 18 |
| Citric Acid¹⁶ | 36.5 | 36.5 |
| Sodium bicarbonate¹⁷ | 12.5 | 12.5 |
| Fragrance | 2 | 2 |
| GDL (Glucono-delta-lactone)¹⁹ | 13.5 | 13.5 |
| Sodium benzoate²⁰ | 9.5 | 9.5 |
| Surfactant - Lathanol LAL⁴⁰ | 8.0 | — |
| Surfactant - Amisoft CS-11⁴¹ | — | 8.0 |

¹⁶Citric acid (S.A. Citrique Belge N.V., Tienen, Belgium)
¹⁷Sodium bicarbonate (Solvay USA Inc., Albright, WV, USA)
¹⁹Glucono-delta-lactone (Jungbunzlauer Suisse AG, Basel, Switzerland)
²⁰Sodium benzoate (Emerald Kalama Chemical, Kalama, WA, USA)
⁴⁰Lathanol LAL—sodium lauryl sulfoacetate (Stepan Company, Northfield, IL, USA)
⁴¹Amisoft CS-11—sodium cocoyl glutamate (Ajinomoto, Tokyo Japan)

### Example 58

A formulation incorporating the dewatered product of Mix 3 described above was prepared. After 900 minutes of reaction time, Mix 3 (75 wt % soda ash, 17 wt % triacetin, and 8 wt % Hostapon® CGN) was used to prepare a multi-surface cleaner. The formulation is shown in Table 10.

TABLE 10
Multi-surface cleaner Formulation

| Component | Amount (wt %) |
|---|---|
| Dewatered Mix 3 | 40 |
| Citric Acid¹⁶ | 48 |
| SLS (sodium lauryl sulfate)²¹ | 2 |
| Sodium acetate²⁷ | 8 |
| Sodium gluconate³¹ | 2 |

¹⁶Citric acid (S.A. Citrique Belge N.V., Tienen, Belgium)
²¹Sodium lauryl sulfate (Stepan Company, Northfield, IL, USA)
²⁷Sodium acetate (Niacet Corporation, Niagara Falls, NY, USA)
³¹Sodium gluconate (PMP Fermentation Products, Inc., Peoria, IL, USA)

The components shown in Table 10 were blended together to make a final blend having a weight of 200 g. Then, 10 grams of this blend was pressed into a tablet with a die size of 1.063″ in diameter on a CARVER PRESS at roughly 8 metric tons. The tablet was added to 690 mL of water to prepare the multi-surface cleaner. The tablet showed excellent visual foam, very good dissolution speed and the resulting solution had good clarity.

1. A method for removing water from an aqueous functional ingredient composition containing more than 10 wt % water, the method comprising:
mixing in a mixer a solid base, a polyester solvent, and the aqueous functional ingredient composition at room temperature to produce a dewatered product,
wherein:
the amount of water in the dewatered product is no more than 33% of a starting amount of the water in the aqueous functional ingredient composition, and
a difference between a total weight of the solid base, the polyester solvent, and the aqueous functional ingredient composition added to the mixer and a final weight of the dewatered product is 2% or less.

2. The method of claim 1, wherein a functional ingredient in the aqueous functional ingredient composition comprises a surfactant, a dispersant, an anti-redeposition agent, a solubility modifier, a rinse aid, an odor counteractant, a chelating agent, a conditioning agent, an anti-static agent, a soil shielding agent, a soil releasing agent, a color protection agent, or a combination thereof.

3. The method of claim 1, wherein the starting amount of water in the aqueous functional ingredient composition is in a range of 10 wt % to 98 wt %.

4. The method of claim 1, wherein the solid base comprises an alkaline material that is solid at room temperature and that has a pH in the range of about 8 to 13.5.

5. The method of claim 1, wherein the solid base comprises an alkali metal salt, an alkaline-earth metal salt, an aminopolycarboxylate-based chelating agent, a tetrasodium iminodisuccinate complexing agent, or combinations thereof, or wherein the solid base comprises one or more selected from the group consisting of sodium acetate, potassium acetate, sodium carbonate, potassium carbonate, calcium carbonate, magnesium carbonate, sodium bicarbonate, potassium bicarbonate, sodium sesquicarbonate, sodium silicate, potassium silicate, sodium metasilicate, potassium metasilicate, methylglycine N,N-diacetic acid trisodium salt (MGDA), glutamate diacetate tetrasodium salt (GLDA), and tetrasodium iminodisuccinate.

6. (canceled)

7. (canceled)

8. The method of claim 1, wherein the polyester solvent comprises an ester compound that includes three or more 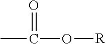
moieties, or wherein the polyester solvent comprises a citric acid ester, a lactic acid ester, a glyceryl ester, or a combination thereof.

9. (canceled)

10. The method of claim 8, wherein the polyester solvent comprises triethyl citrate, acetyltriethyl citrate, tributyl citrate, acetyltributyl citrate, trihexyl citrate, n-butyryl-tri (n-hexyl)-citrate, trioctyl citrate, tributyl aconitate, glycerol triacetate (triacetin), glycerol tripropanoate (tripropionin), glyceryl tributyrate (tributyrin), glycerol tricaprate (tricaprin), glyceryl trioleate (triolein), glyceryl tristearate (stearin), glyceryl tripalmitate (tripalmitin), pentaerythrityl tetraethylhexanoate, or a combination thereof.

11. (canceled)

12. The method of claim 1, wherein a ratio of the solid base to the functional ingredient composition is in a range of about 5:1 to 15:1, wherein a ratio of the polyester solvent to the functional ingredient composition is in a range of about 1:1 to 3:1, and the dewatered product is in a form of a flowable powder.

13. The method of claim 12, wherein a ratio of the solid base to the polyester solvent is in a range of about 3:1 to 8.5:1.

14. (canceled)

15. The method of claim 1, wherein a ratio of the solid base to the functional ingredient composition is in a range of about 3:1 to 1:5, wherein a ratio of the solid base to the polyester solvent is in a range of about 3.5:1 to 1:11, and the dewatered product is in a form of a viscous fluid.

16. (canceled)

17. The method of claim 15, wherein a ratio of the polyester solvent to the functional ingredient composition is in a range of about 4:1 to 1:4.

18. The method of claim 12, wherein the dewatered product is allowed to age for a time period of 3 hours to 8 hours resulting in a dewatered product in a form of a gel, or wherein the dewatered product is allowed to age for a time period of 18 hours to 24 hours resulting in a dewatered product in a form of a putty.

19. (canceled)

20. The method of claim 12, further comprising blending the dewatered product with a flow aid to yield a flowable product, wherein the flow aid comprises:
a) sodium chloride, potassium chloride sodium sulfate, potassium sulfate, or a combination thereof;
b) a sodium and/or a potassium salt of at least one of an acetate, carbonate, bicarbonate, citrate, phosphate, silicate, aluminate, or a combination thereof; or
c) a combination of a) and b).

21. (canceled)

22. The method of claim 20, wherein a ratio of the flow aid to the dewatered product is from about 1:1 to 5:1 and/or where the blending is performed for a time of about 10 minutes or more.

23. (canceled)

24. The method of claim 1, wherein the mixer is a KitchenAid® countertop stand mixer, a Hobart® planetary mixer, a vee-blender, a vee-cone blender, a rotary batch mixer, a ribbon blender, a paddle blender, a plow blender, a screw mixer, a turbulizer, a Nauta® mixer, a double arm kneader mixer, or a combinations thereof, wherein the mixing is carried out at room temperature under atmospheric pressure, and/or wherein the mixing is performed for a period of 10 to 60 minutes.

25. (canceled)

26. The method of claim 1, wherein an amount of water in the dewatered product is no more than about 33% of a starting amount of the water in the aqueous functional ingredient composition.

27. (canceled)

28. A dewatered product produced by the method of claim 1.

29. A composition, comprising the dewatered product of claim 28.

30-35. (canceled)

36. A unit dosage form, comprising the dewatered product of claim 28.

37-38. (canceled)
